(19) United States
(12) Patent Application Publication
(10) Pub. No.: US 2026/0089666 A1
(43) Pub. Date: Mar. 26, 2026

(54) USER EQUIPMENT (UE)

(71) Applicant: SHARP KABUSHIKI KAISHA, Sakai City, Osaka (JP)

(72) Inventors: SHUICHIRO CHIBA, Sakai City, Osaka (JP); YASUO SUGAWARA, Sakai City, Osaka (JP)

(21) Appl. No.: 19/154,554

(22) PCT Filed: Nov. 2, 2023
(86) PCT No.: PCT/JP2023/039629

§ 371 Date: Aug. 7, 2025

(30) Foreign Application Priority Data
Apr. 7, 2023 (JP) 2023-062724

(51) Int. Cl. H04W 60/02; H04W 84/06

(52) U.S. Cl. CPC H04W 60/02; H04W 84/06

(57) ABSTRACT

Provided are identification information for transmitting and/or receiving information necessary for performing a network-initiated registration update procedure performed in a case that a UE returns to coverage from outside of the coverage of NR satellite access between the UE and a network in advance, performing of the registration update procedure based on the identification information, control of a form of performing the registration update procedure, and control of a condition for performing the registration update procedure.

### TECHNICAL FIELD

The present example relates to a User Equipment (UE).

This application claims priority to JP 2023-062724 filed on Apr. 7, 2023, the contents of which are incorporated herein by reference.

### BACKGROUND ART

In the 3rd Generation Partnership Project (3GPP: trade name), system architecture of a 5G System (5GS), which is a fifth generation (5G) mobile communication system, has been studied, and discussions are underway to support new procedures and new functions (see NPLs 1 to 4). In Release 18 of the 5G standard, an architecture for 5G communication based on artificial satellites (also simply referred to as “satellites”), a procedure for communication and control, and the like have been studied (see NPL 4).

### CITATION LIST

### Non Patent Literature

NPL 1: 3GPP TS 23.501 V18.1.0 (2023-03); 3rd Generation Partnership Project; Technical Specification Group Services and System Aspects; System architecture for the 5G System (5GS); Stage 2 (Release 18)

NPL 2: 3GPP TS 23.502 V18.1.0 (2023-03); 3rd Generation Partnership Project; Technical Specification Group Services and System Aspects; Procedures for the 5G System (5GS); Stage 2 (Release 18)

NPL 3: 3GPP TS 24.501 V18.2.0 (2023-03); 3rd Generation Partnership Project; Technical Specification Group Core Network and Terminals; Non-Access-Stratum (NAS) protocol for 5G System (5GS); Stage 3; (Release 18)

NPL 4: 3GPP TR 23.700-28 V18.1.0 (2023-03); 3rd Generation Partnership Project; Technical Specification Group Services and System Aspects; Study on Integration of satellite components in the 5G architecture; Phase 2 (Release 18)

### SUMMARY OF INVENTION

### Technical Problem

For the 5G System (5GS), a 5G Core Network (5GCN) which is a new core network has been studied for the purpose of providing various services. Furthermore, an architecture for 5G communication based on artificial satellites (also simply referred to as “satellites”) has been studied.

Currently, for such a communication architecture that uses satellites as a radio technology (radio access technology) for connecting user equipment (UE) and core networks, studies have been conducted on extension of procedures, messages, or parameters from those in the past in consideration of characteristics of radio connection via satellites.

Meanwhile, information necessary for performing a registration update procedure initiated by a network which is performed to update information, such as a location of the UE, in a case that the UE connected to the network via New Radio (NR) satellite access returns to coverage from outside of the coverage in communication via a satellite providing discontinuous coverage, transmission and/or reception of the information, and behaviors and processing of the UE and each apparatus are not clarified.

The present example is made in light of the circumstances as described above, and has an object to provide a method for appropriately controlling performing of a registration update procedure initiated by a network and a form of the performing in a case that the UE returns to coverage from the outside of the coverage of NR satellite access.

### Solution to Problem

A User Equipment (UE) according to the present example is a UE including a transmission and/or reception unit and a controller, wherein the transmission and/or reception unit receives a configuration update command message or a registration accept message that includes first identification information from a network via satellite access, the first identification information being identification information indicating that the network requests the UE to initiate a registration update procedure for the network via the satellite access in a case that the UE returns to coverage of the satellite access from outside of the coverage of the satellite access, and the first identification information being further related to a Public Land Mobile Network (PLMN), and/or a Radio Access Technology (RAT) type, and/or an access type, and/or an area, and in the case that the UE returns to the coverage of the satellite access from the outside of the coverage of the satellite access, the controller initiates the registration update procedure for the network via the satellite access, based on the first identification information.

### Advantageous Effects of Invention

According to the present example, provided is a measure for transmitting and/or receiving parameters between a UE and a network related to a registration update procedure initiated by the network and appropriately performing control based on the parameters in a case that the UE connected to a 5G network via NR satellite access providing discontinuous coverage returns to coverage from outside of the coverage of the NR satellite access.

### BRIEF DESCRIPTION OF DRAWINGS

FIG. 1 is a diagram illustrating an overview of a mobile communication system (EPS/5GS).

FIG. 2 is a diagram illustrating a detailed configuration of the mobile communication system (EPS/5GS).

FIG. 3 is a diagram illustrating an apparatus configuration of a UE.

FIG. 4 is a diagram illustrating a configuration of an access network apparatus (gNB) in the 5GS.

FIG. 5 is a diagram illustrating a configuration of a core network apparatus (AMF/SMF/UPF) in the 5GS.

FIG. 6 is a diagram illustrating a registration procedure.

FIG. 7 is a diagram illustrating a mobility management procedure initiated by a network.

### DESCRIPTION OF EMBODIMENTS

Preferred embodiments for carrying out the present example will be described below with reference to the drawings. Note that an embodiment of a mobile communication system to which the present example is applied will be described as an example in the present embodiment.

### 1. Overview of System

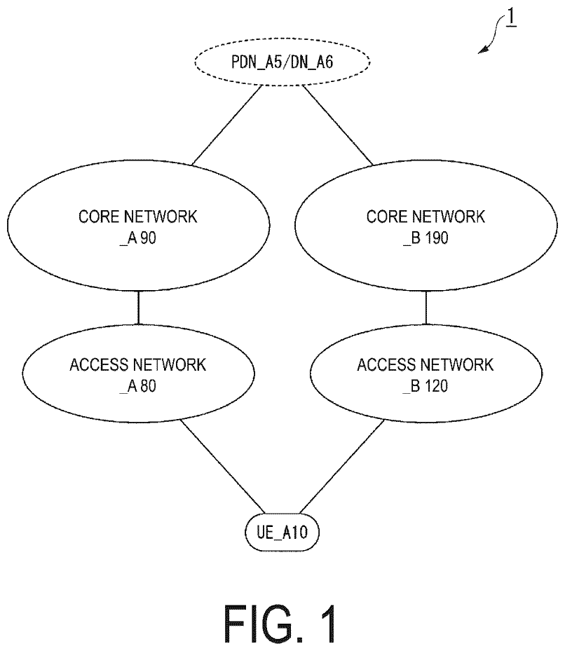

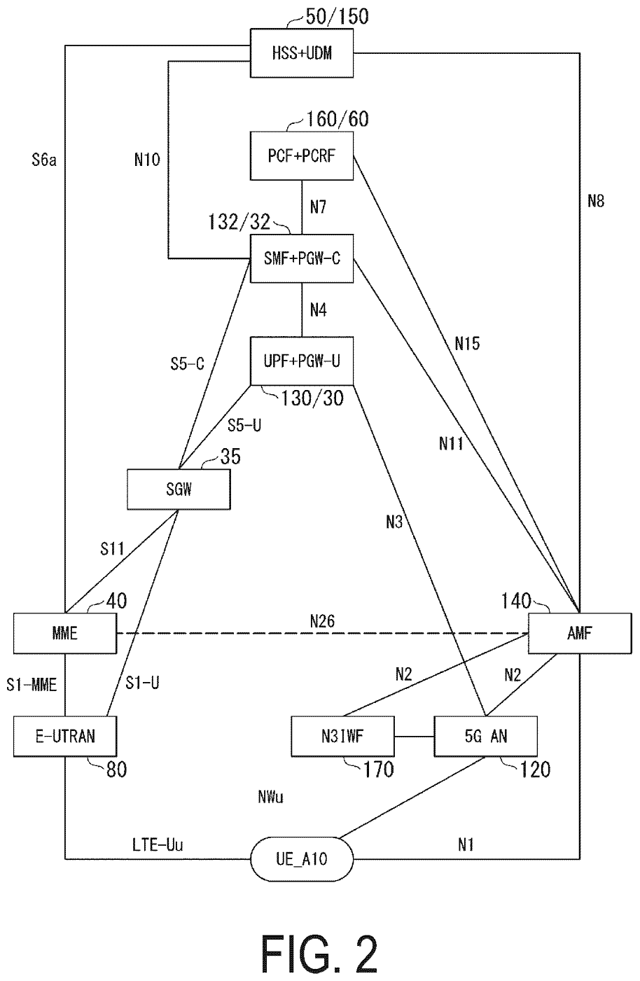

First, FIG. 1 is a diagram illustrating an overview of a mobile communication system 1 used in each embodiment, and FIG. 2 is a diagram illustrating a detailed configuration of the mobile communication system 1.

FIG. 1 illustrates the mobile communication system 1 including a UE_A 10, an access network_A 80, a core network_A 90, a Packet Data Network (PDN)_A 5, an access network_B 120, a core network_B 190, and a Data Network (DN)_A 6.

In the following description, the reference numerals of these apparatuses and functions may be omitted, as in a UE, an access network_A, a core network_A, a PDN, an access network_B, a core network_B, a DN, and the like.

FIG. 2 illustrates apparatuses and functions such as the UE_A 10, an E-UTRAN 80, an MME 40, an SGW 35, a PGW-U 30, a PGW-C 32, a PCRF 60, an HSS 50, a 5G AN 120, an AMF 140, a UPF 130, an SMF 132, a PCF 160, a UDM 150, and an N3IWF 170, and interfaces for connecting these apparatuses and functions to each other.

In the following description, the reference numerals of these apparatuses and functions may be omitted as in a UE, an E-UTRAN, an MME, an SGW, a PGW-U, a PGW-C, a PCRF, an HSS, a 5G AN, an AMF, a UPF, an SMF, a PCF, a UDM, an N3IWF, and the like.

Note that an Evolved Packet System (EPS) that is a 4G system includes an access network_A and a core network_A and may further include a UE and/or a PDN. A 5G System (5GS) that is a 5G system includes a UE, an access network_B, and a core network_B and may further include a DN.

The UE is an apparatus that can be connected to a network service over 3GPP access (also referred to as a 3GPP access network or a 3GPP AN) and/or non-3GPP access (also referred to as a non-3GPP access network or a non-3GPP AN). The UE may be a terminal apparatus capable of performing radio communication, such as a mobile phone or a smartphone, and may be a terminal apparatus that can be connected to both the EPS and the 5GS. The UE may include a Universal Integrated Circuit Card (UICC) and an Embedded UICC (eUICC). Note that the UE may be referred to as user equipment or a terminal apparatus.

The access network_A corresponds to an Evolved Universal Terrestrial Radio Access Network (E-UTRAN) and/or a wireless LAN access network. In the E-UTRAN, one or more evolved Node Bs (eNBs) 45 are deployed. Note that, in the following description, the reference numeral of the eNB 45 may be omitted as in eNB. In a case that there are multiple eNBs, the eNBs are connected to each other via, for example, an X2 interface. One or more access points are deployed on the wireless LAN access network.

The access network_B corresponds to a 5G access network (5G AN). The 5G AN includes an NG Radio Access Network (NG-RAN) and/or a non-3GPP access network. One or more NR NodeBs (gNBs) 122 are deployed on the NG-RAN. Note that in the following description, the symbol for the gNB 122 may be omitted as a gNB. The gNB is a node that provides a New Radio (NR) user plane and control plane to the UE, and is connected to a 5GCN via an NG interface (including an N2 interface or an N3 interface). In other words, the gNB is a base station apparatus newly designed for the 5GS and has functions different from those of the base station apparatus (eNB) used in the EPS that is a 4G system. In a case that there are multiple gNBs, the gNBs are connected to each other via, for example, an Xn interface.

A non-3GPP access network may be an untrusted non-3GPP access network or a trusted non-3GPP access network. Here, the untrusted non-3GPP access network may be a non-3GPP access network that does not manage security on the access network, for example, a public wireless LAN. On the other hand, the trusted non-3GPP access network may be an access network defined by 3GPP and may include a trusted non-3GPP access point (TNAP) and a trusted non-3GPP Gateway function (TNGF).

In the following description, the E-UTRAN and the NG-RAN may be referred to as 3GPP access. The wireless LAN access network and the non-3GPP AN may be referred to as non-3GPP access. Nodes deployed on the access network_B may be collectively referred to as NG-RAN nodes.

In the following description, the access network_A, and/or the access network_B, and/or an apparatus included in the access network_A, and/or an apparatus included in the access network_B may be referred to as an access network or an access network apparatus.

The core network_A corresponds to an Evolved Packet Core (EPC). In the EPC, for example, a Mobility Management Entity (MME), a Serving Gateway (SGW), a Packet Data Network Gateway (PGW)-U, a PGW-C, a Policy and Charging Rules Function (PCRF), a Home Subscriber Server (HSS), and the like are deployed.

The core network_B corresponds to a 5G Core Network (5GCN). An Access and Mobility Management Function (AMF), a User Plane Function (UPF), a Session Management Function (SMF), a Policy Control Function (PCF), a Unified Data Management (UDM), and the like are deployed on the 5GCN. Here, the 5GCN may be referred to as a 5GC.

In the following description, the core network_A, and/or the core network_B, an apparatus included in the core network_A, and/or an apparatus included in the core network_B may be referred to as a core network, a core network apparatus, or an intra-core network apparatus.

The core network (the core network_A and/or the core network_B) may refer to an IP mobile communication network operated by a mobile communication (Mobile Network Operator (MNO)) connecting the access network (the access network_A and/or the access network_B) and the PDN and/or the DN, a core network for a mobile communication operator that operates and manages the mobile communication system 1, or a core network for a virtual mobile communication operator and a virtual mobile communication service provider such as a Mobile Virtual Network Operator (MVNO) and a Mobile Virtual Network Enabler (MVNE).

Although FIG. 1 illustrates a case that the PDN and the DN are the same, the PDN and the DN may be different. The PDN may be a Data Network (DN) that provides communication services to the UE. Note that the DN may be configured as a packet data service network or may be configured for each service. In addition, the PDN may include a connected communication terminal. Thus, “to be connected to the PDN” may mean “to be connected to a communication terminal and a server apparatus deployed in the PDN”. Furthermore, “to transmit and/or receive user data to and/or from the PDN” may mean “to transmit and/or receive user data to and/or from a communication terminal and a server apparatus deployed in the PDN”. Note that the PDN may be referred to as a DN, and the DN may be referred to as a PDN.

In the following, at least some of the access network_A, the core network_A, the PDN, the access network_B, the core network_B, and the DN, and/or one or more apparatuses included in these may be referred to as a network or a network apparatus. In other words, the expression that “the network and/or the network apparatus transmits and/or receives a message and/or performs a procedure” means that “at least some of the access network A, the core network_A, the PDN, the access network_B, the core network_B, and the DN, and/or one or more apparatuses included in these transmit and/or receive a message and/or perform a procedure”.

The UE can be connected to the access network. The UE can be connected to the core network over the access network. Furthermore, the UE can be connected to the PDN or the DN over the access network and the core network. In other words, the UE can transmit and/or receive (communicate) user data to and/or from the PDN or the DN. In a case that user data is transmitted and/or received, not only Internet Protocol (IP) communication but also non-IP communication may be used.

Here, IP communication refers to data communication using an IP, and data is transmitted and/or received using IP packets. Each IP packet includes an IP header and a payload part. In the payload part, data transmitted and/or received by the apparatuses and functions included in the EPS and the apparatuses and functions included in the 5GS may be included. Non-IP communication refers to data communication performed without using IP, in which data is transmitted and/or received in a form different from the structure of an IP packet. For example, non-IP communication may be data communication implemented through transmission and/or reception of application data to which an IP header is not added, or user data transmitted and/or received by the UE may be transmitted and/or received with another header such as a MAC header and an Ethernet (trade name) frame header added.

Apparatuses which are not illustrated in FIG. 2 may be included in the access network A, the core network_A, the access network_B, the core network_B, the PDN_A, and the DN_A. For example, the core network_A and/or the core network_B may include an Authentication Server Function (AUSF) and an Authentication, authorization, and accounting (AAA) server (AAA-S).

Here, the AUSF is a core network apparatus provided with an authentication function for 3GPP access and non-3GPP access. Specifically, the AUSF is a network function unit that receives an authentication request for 3GPP access and/or non-3GPP access from the UE and performs an authentication procedure.

The AAA server is an apparatus that is connected directly to the AUSF or indirectly to the AUSF via another network apparatus and has authentication, authorization, and billing functions. The AAA server may be a network apparatus within the core network. Note that the AAA server may not be included in the core network_A and/or the core network_B and may be included in the PLMN. In other words, the AAA server may be a core network apparatus or may be an apparatus outside the core network. For example, the AAA server may be a server apparatus within the PLMN managed by a 3rd party.

Note that, although each of the apparatuses and functions is illustrated one by one for simplicity in FIG. 2, multiple similar apparatuses and functions may be included in the mobile communication system 1. Specifically, multiple apparatuses and functions such as multiple pieces of UE_A 10, E-UTRANs 80, MMEs 40, SGWs 35, PGW-Us 30, PGW-Cs 32, PCRFs 60, HSSs 50, 5G ANs 120, AMFs 140, UPFs 130, SMFs 132, PCFs 160, and/or UDMs 150 may be included in the mobile communication system 1.

A UPF_A 235 is connected to the DN, the SMF, other UPFs and the access network. The UPF_A 235 may play roles of an anchor to intra-RAT mobility or inter-RAT mobility, Packet routing & forwarding, an Uplink Classifier (UL CL) function to support routing of multiple traffic flows for one DN, a Branching point function to support a multi-homed PDU session, QoS processing for a user plane, verification of uplink traffic, buffering of downlink packets, a function of triggering Downlink Data Notification, and the like. The UPF_A 235 may be a relay apparatus that transfers the user data as a gateway between the DN and the core network_B 190. Note that the UPF_A 235 may serve as a gateway for IP communication and/or non-IP communication. Furthermore, the UPF_A 235 may have a function of transferring IP communication or a function to perform conversion between non-IP communication and IP communication. Furthermore, the multiple gateways deployed may serve as gateways for connecting the core network_B 190 with a single DN. Note that the UPF_A 235 may have connectivity with another NF or may be connected to each apparatus via another NF.

Note that, a UPF_C 239 (also referred to as a branching point or an uplink classifier), which is a UPF different from the UPF_A 235, may be present as an apparatus or NF between the UPF_A 235 and the access network. With the UPF_C 239 present, the PDU session between the UE and the DN is established via the access network, the UPF_C 239, and the UPF_A 235.

The UPF 130 may be an apparatus similar to the UPF_A 235. Note that the UPF 130 and the UPF_A 235 may be described with the symbols thereof omitted, like the UPF.

### 2. Configuration of Each Apparatus

Next, a configuration of each apparatus (the UE, and/or the access network apparatus, and/or the core network apparatus) used in each embodiment will be described with reference to the drawings. Note that each apparatus may be configured as physical hardware, may be configured as logical (virtual) hardware configured in general-purpose hardware, or may be configured as software. At least a part (including all) of the functions of each apparatus may be configured as physical hardware, logical hardware, or software.

Note that each storage unit (a storage unit_A 340, a storage unit_A 440, a storage unit_B 540, a storage unit_A 640, and a storage unit_B 740) in each apparatus and function to be described later includes, for example, a semiconductor memory, a Solid State Drive (SSD), a Hard Disk Drive (HDD), or the like. Each storage unit can store not only information originally configured at the time of being shipped, but also various pieces of information transmitted and/or received to and/or from apparatuses and functions (for example, the UE, and/or the access network apparatus, and/or the core network apparatus, and/or the PDN, and/or the DN) other than the apparatus and functions of each storage unit. Each storage unit can store identification information, control information, flags, parameters, and the like included in a control message transmitted and/or received in various communication procedures to be described later. Each storage unit may store these pieces of information for each UE. In a case that each storage unit performs interworking between the 5GS and the EPS, each storage unit can store a control message and user data transmitted and/or received to and/or from the apparatuses and functions included in the 5GS and/or the EPS. In this case, not only data transmitted and/or received over the N26 interface but also data transmitted and/or received without using the N26 interface can be stored.

### 2.1. Apparatus Configuration of UE

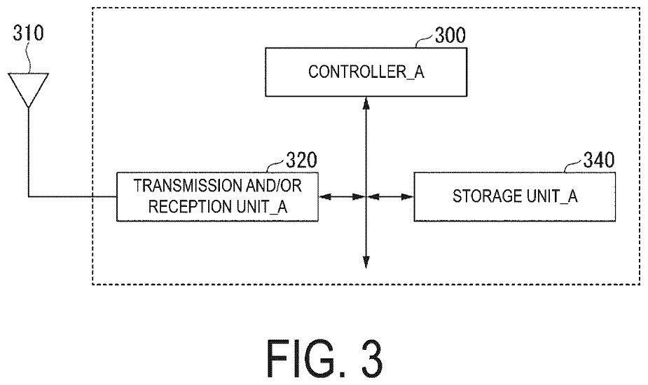

First, an apparatus configuration example of the User Equipment (UE) will be described with reference to FIG. 3. The UE includes a controller_A 300, an antenna 310, a transmission and/or reception unit_A 320, and a storage unit_A 340. The controller_A 300, the transmission and/or reception unit_A 320, and the storage unit_A 340 are connected via a bus. The transmission and/or reception unit_A 320 is connected to the antenna 310.

The controller_A 300 is a function unit that controls overall operations and functions of the UE. The controller_A 300 reads and performs various programs stored in the storage unit_A 340 as necessary, and thereby implements various types of processing in the UE.

The transmission and/or reception unit_A 320 is a function unit that performs radio communication with a base station apparatus (the eNB or the gNB) within the access network via the antenna. In other words, with the use of the transmission and/or reception unit_A 320, the UE can transmit and/or receive user data and/or control information to and/or from the access network apparatus, and/or the core network apparatus, and/or the PDN, and/or the DN.

To provide detailed description with reference to FIG. 2, by using the transmission and/or reception unit_A 320, the UE can communicate with the base station apparatus (eNB) within the E-UTRAN over an LTE-Uu interface. The UE can communicate with the base station apparatus (gNB) within the 5G AN with the use of the transmission and/or reception unit_A 320. The UE can transmit and/or receive a Non-Access-Stratum (NAS) message to and/or from the AMF over an NI interface with the use of the transmission and/or reception unit_A 320. However, the NI interface is a logical interface, and thus communication between the UE and the AMF is actually performed over the 5G AN.

The storage unit_A 340 is a function unit that stores programs, user data, control information, and the like necessary for each operation of the UE.

### 2.2. Apparatus Configuration of gNB

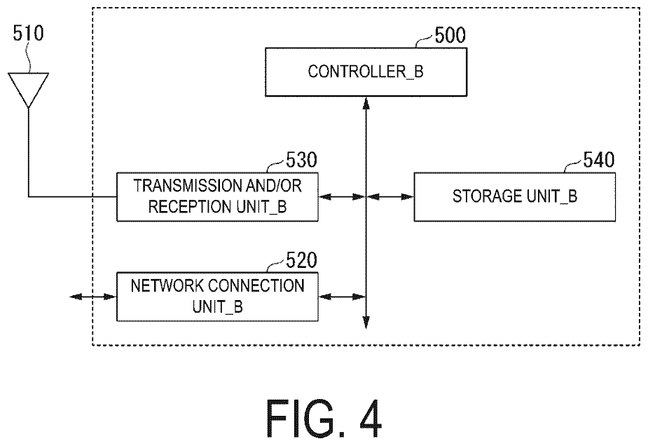

Next, an apparatus configuration example of the gNB will be described with reference to FIG. 4. The gNB includes a controller_B 500, an antenna 510, a network connection unit_B 520, a transmission and/or reception unit_B 530, and a storage unit_B 540. The controller_B 500, the network connection unit_B 520, the transmission and/or reception unit_B 530, and the storage unit B 540 are connected via a bus. The transmission and/or reception unit_B 530 is connected to the antenna 510.

The controller_B 500 is a function unit that controls overall operations and functions of the gNB. The controller_B 500 reads and performs various programs stored in the storage unit_B 540 as necessary, and thereby implements various types of processing in the gNB.

The network connection unit_B 520 is a function unit for the gNB to communicate with the AMF and/or the UPF. In other words, with the use of the network connection unit_B 520, the gNB can transmit and/or receive user data and/or control information to and/or from the AMF and/or the UPF.

The transmission and/or reception unit_B 530 is a function unit that performs radio communication with the UE via the antenna 510. In other words, with the use of the transmission and/or reception unit_B 530, the gNB can transmit and/or receive user data and/or control information to and/or from the UE.

To provide detailed description with reference to FIG. 2, by using the network connection unit_B 520, the gNB within the 5G AN can communicate with the AMF over the N2 interface and can communicate with the UPF over the N3 interface. The gNB can communicate with the UE with the use of the transmission and/or reception unit_B 530.

The storage unit_B 540 is a function unit that stores programs, user data, control information, and the like necessary for each operation of the gNB.

### 2.3. Apparatus Configuration of AMF

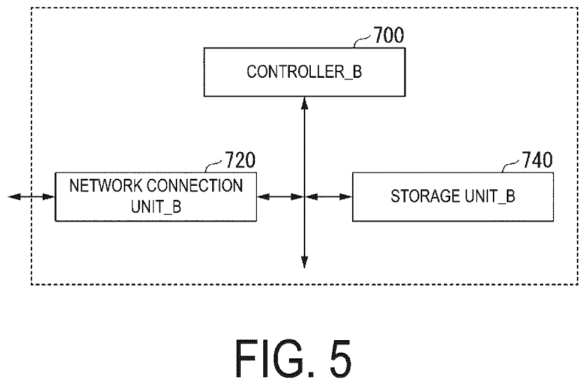

Next, an apparatus configuration example of the AMF will be described with reference to FIG. 5. The AMF includes a controller_B 700, a network connection unit_B 720, and a storage unit_B 740. The controller_B 700, the network connection unit_B 720, and the storage unit_B 740 are connected via a bus. The AMF may be a node that handles a control plane. The AMF may be a network apparatus. In other words, for example, the network apparatus in the present specification may mean the AMF.

The controller_B 700 is a function unit that controls overall operations and functions of the AMF. The controller_B 700 reads and performs various programs stored in the storage unit_B 740 as necessary, and thereby implements various types of processing in the AMF.

The network connection unit_B 720 is a function unit for the AMF to connect to the base station apparatus (gNB) within the 5G AN, and/or the SMF, and/or the PCF, and/or the UDM, and/or an SCEF. In other words, with the use of the network connection unit_B 720, the AMF can transmit and/or receive user data and/or control information to and/or from the base station apparatus (gNB) in the 5G AN, and/or the SMF, and/or the PCF, and/or the UDM, and/or the SCEF. In other words, for example, the network connection unit may be a transmission and/or reception unit.

To provide detailed description with reference to FIG. 2, by using a network connection unit_A 620, the AMF within the 5GCN can communicate with the gNB over the N2 interface, can communicate with the UDM over an N8 interface, can communicate with the SMF over an N11 interface, and can communicate with the PCF over an N15 interface. The AMF can transmit and/or receive a NAS message to and/or from the UE over the N1 interface with the use of the network connection unit_A 620. However, the N1 interface is a logical interface, and thus communication between the UE and the AMF is actually performed over the 5G AN. In a case that the AMF supports an N26 interface, the AMF can communicate with the MME over the N26 interface with the use of the network connection unit_A 620.

The storage unit_B 740 is a function unit that stores programs, user data, control information, and the like necessary for each operation of the AMF.

Note that the AMF has a function of exchanging a control message with the RAN using the N2 interface, a function of exchanging a NAS message with the UE using the N1 interface, a function of performing encryption and integrity protection of a NAS message, a Registration management (RM) function, a Connection management (CM) function, a Reachability management function, a Mobility management function for the UE or the like, a function of transferring a Session Management (SM) message between the UE and the SMF, an Access Authentication (Access Authorization) function, a security anchor function (Security Anchor Functionality (SEA)), a Security Context Management (SCM) function, a function of supporting the N2 interface for a Non-3GPP Interworking Function (N3IWF), a function of supporting transmission and/or reception of a NAS signal to an/or from the UE via the N3IWF, a function of authenticating the UE connected via the N3IWF, and the like.

In registration management, an RM state for each UE is managed. The RM state may be synchronized between the UE and the AMF. The RM state includes a deregistered state (RM-DEREGISTERED state) and a registered state (RM-REGISTERED state). In the RM-DEREGISTERED state, because the UE is not registered with the network, the AMF is in a state of being unable to reach the UE, because a UE context in the AMF does not have location information and routing information that are valid for the UE. In the RM-REGISTERED state, because the UE is registered in the network, the UE can receive a service that requires registration with the network. Note that the RM state may be referred to as a 5GMM state. In this case, the RM-DEREGISTERED state may be referred to as a 5GMM-DEREGISTERED state, and the RM-REGISTERED state may be referred to as a 5GMM-REGISTERED state.

In other words, 5GMM-REGISTERED may be a state in which each apparatus establishes a 5GMM context, or may be a state in which each apparatus establishes a PDU session context. Note that, in a case that each apparatus is in 5GMM-REGISTERED, the UE_A 10 may start transmission and/or reception of user data and a control message, or may respond to paging. Furthermore, note that, in a case that each apparatus is in 5GMM-REGISTERED, the UE_A 10 may perform a registration procedure other than a registration procedure for initial registration, and/or a service request procedure.

In addition, 5GMM-DEREGISTERED may be a state in which each apparatus does not establish the 5GMM context, may be a state in which the location information of the UE_A 10 is not known to the network, or may be a state in which the network is unable to reach the UE_A 10. Note that, in a case that each apparatus is in 5GMM-DEREGISTERED, the UE_A 10 may initiate the registration procedure, or may perform the registration procedure to thereby establish the 5GMM context.

In connection management, a CM state for each UE is managed. The CM state may be synchronized between the UE and the AMF. The CM state includes a non-connected state (CM-IDLE state) and a connected state (CM-CONNECTED state). In the CM-IDLE state, the UE is in the RM-REGISTERED state, but does not have NAS signalling connection established with the AMF via the N1 interface. In the CM-IDLE state, the UE has neither connection of the N2 interface (N2 connection) nor connection of the N3 interface (N3 connection). On the other hand, in the CM-CONNECTED state, the UE has NAS signalling connection established with the AMF via the NI interface. In the CM-CONNECTED state, the UE may have connection of the N2 interface (N2 connection) and/or connection of the N3 interface (N3 connection).

Furthermore, in connection management, management may be performed separately for the CM state in 3GPP access and the CM state in non-3GPP access. In this case, the CM state in 3GPP access may include a non-connected state in 3GPP access (CM-IDLE state over 3GPP access) and a connected state in 3GPP access (CM-CONNECTED state over 3GPP access). Furthermore, the CM state in non-3GPP access may include a non-connected state in non-3GPP access (CM-IDLE state over non-3GPP access) and a connected state in non-3GPP access (CM-CONNECTED state over non-3GPP access). Note that the non-connected state may be referred to as an idle mode, and a connected state mode may be referred to as a connected mode.

Note that the CM state may be referred to as a 5GMM mode. In this case, the non-connected state may be referred to as a 5GMM non-connected mode (5GMM-IDLE mode), and the connected state may be referred to as a 5GMM connected mode (5GMM-CONNECTED mode). In addition, the non-connected state in 3GPP access may be referred to as a 5GMM non-connected mode in 3GPP access (5GMM-IDLE mode over 3GPP access), and the connected state in 3GPP access may be referred to as a 5GMM connected mode in 3GPP access (5GMM-CONNECTED mode over 3GPP access). In addition, the non-connected state in non-3GPP access may be referred to as a 5GMM non-connected mode in non-3GPP access (5GMM-IDLE mode over non-3GPP access), and the connected state in non-3GPP access may be referred to as a 5GMM connected mode in non-3GPP access (5GMM-CONNECTED mode over non-3GPP access). Note that the 5GMM non-connected mode may be referred to as an idle mode, and the 5GMM connected mode may be referred to as a connected mode.

One or more AMFs may be deployed within the core network_B. The AMF may be a Network Function (NF) that manages one or more Network Slice Instances (NSIs). The AMF may be a common CP function (Common Control Plane Network Function (CPNF)(CCNF)) shared among multiple NSIs.

Note that, in a case that the UE connects to the 5GS over non-3GPP access, the N3IWF is an apparatus and/or a function deployed between non-3GPP access and the 5GCN.

### 2.4. Apparatus Configuration of SMF

Next, an apparatus configuration example of the SMF will be described with reference to FIG. 5. The SMF includes a controller_B 700, a network connection unit_B 720, and a storage unit_B 740. The controller_B 700, the network connection unit_B 720, and the storage unit_B 740 are connected via a bus. The SMF may be a node that handles the control plane.

The controller_B 700 is a function unit that controls overall operations and functions of the SMF. The controller_B 700 reads and performs various programs stored in the storage unit_B 740 as necessary, and thereby implements various types of processing in the SMF.

The network connection unit_B 720 is a function unit for the SMF to connect to the AMF, and/or the UPF, and/or the PCF, and/or the UDM. In other words, with the use of the network connection unit_B 720, the SMF can transmit and/or receive user data and/or control information to and/or from the AMF, and/or the UPF, and/or the PCF, and/or the UDM.

To provide detailed description with reference to FIG. 2, by using of the network connection unit_A 620, the SMF in the 5GCN can communicate with the AMF over the N11 interface, can communicate with the UPF over the N4 interface, can communicate with the PCF over an N7 interface, and can communicate with the UDM over an N10 interface.

The storage unit_B 740 is a function unit that stores programs, user data, control information, and the like necessary for each operation of the SMF.

The SMF has a Session Management function for managing establishment, modification, and release of a PDU session, a function of IP address allocation to the UE and management thereof, a function of selection and control of the UPF, a function of configuring the UPF for routing traffic to an appropriate destination (transmission destination), a function of transmitting and/or receiving an SM part of a NAS message, a function of providing notification of arrival of downlink data (Downlink Data Notification), a function of providing SM information specific to an AN (for each AN) that is transmitted to the AN through the AMF over the N2 interface, a function of determining a Session and Service Continuity mode (SSC mode) for a session, a roaming function, and the like.

### 2.5. Apparatus Configuration of UPF

Next, an apparatus configuration example of the UPF will be described with reference to FIG. 5. The UPF includes a controller_B 700, a network connection unit_B 720, and a storage unit_B 740. The controller_B 700, the network connection unit_B 720, and the storage unit_B 740 are connected via a bus. The UPF may be a node that handles the control plane.

The controller_B 700 is a function unit that controls overall operations and functions of the UPF. The controller_B 700 reads and performs various programs stored in the storage unit_B 740 as necessary, and thereby implements various types of processing in the UPF.

The network connection unit_B 720 is a function unit for the UPF to connect to the base station apparatus (gNB) within the 5G AN, and/or the SMF, and/or the DN. In other words, with the use of the network connection unit_B 720, the UPF can transmit and/or receive user data and/or control information to and/or from the base station apparatus (gNB) within the 5G AN, and/or the SMF, and/or the DN.

To provide detailed description with reference to FIG. 2, by using the network connection unit_A 620, the UPF within the 5GCN can communicate with the gNB over the N3 interface, can communicate with the SMF over the N4 interface, can communicate with the DN over an N6 interface, and can communicate with another UPF over an N9 interface.

The storage unit_B 740 is a function unit that stores programs, user data, control information, and the like necessary for each operation of the UPF.

The UPF has a function as an anchor point for intra-RAT mobility or inter-RAT mobility, a function as an external PDU session point to be interconnected with the DN (that is, a function of transferring user data as a gateway between the DN and the core network_B), a function of routing and transferring packets, an Uplink Classifier (UL CL) function of supporting routing of multiple traffic flows for one DN, a Branching point function of supporting a multi-homed PDU session, a Quality of Service (QoS) processing function for the user plane, a function of verifying uplink traffic, a function of triggering buffering of downlink packets and Downlink Data Notification, and the like.

The UPF may be a gateway for IP communication and/or non-IP communication. The UPF may have a function of transferring IP communication, or a function of conversion between non-IP communication and IP communication. Furthermore, multiple deployed gateways may be gateways for connecting the core network_B and a single DN. Note that the UPF may have connectivity with another NF, and may be connected to each apparatus via another NF.

Note that a user plane refers to user data that is transmitted and/or received between the UE and a network. The user plane may be transmitted and/or received using a PDN connection or a PDU session. Furthermore, in a case of the EPS, the user plane may be transmitted and/or received using an LTE-Uu interface, and/or an S1-U interface, and/or an S5 interface, and/or an S8 interface, and/or an SGi interface. Furthermore, in a case of the 5GS, the user plane may be transmitted and/or received over the interface between the UE and the NG RAN, and/or the N3 interface, and/or the N9 interface, and/or the N6 interface. The user plane may be hereinafter referred to as a U-Plane.

In addition, a control plane refers to a control message that is transmitted and/or received in order to perform communication control of the UE or the like. The control plane may be transmitted and/or received using Non-Access-Stratum (NAS) signalling connection between the UE and the MME. In addition, in a case of the EPS, the control plane may be transmitted and/or received using the LTE-Uu interface and an S1-MME interface. Furthermore, in a case of the 5GS, the control plane may be transmitted and/or received using the interface between the UE and the NG RAN and the N2 interface. The control plane may be hereinafter referred to as a control plane, or may be hereinafter referred to as a C-Plane.

Furthermore, the U-Plane (User Plane (UP)) may be a communication path for transmitting and/or receiving user data, and may include multiple bearers. Furthermore, the C-Plane (Control Plane (CP)) may be a communication path for transmitting and/or receiving a control message, and may include multiple bearers.

### 2.6. Description of Other Apparatuses and/or Functions

Next, other apparatuses and/or functions will be described.

The PCF has a function such as a function of providing policy rules.

The UDM includes an authentication credential processing function, a user identification processing function, an access authentication function, a registration/mobility management function, a subscriber information management function, and the like.

The PCRF is connected to the PGW and/or the PDN and has a function such as a function of performing QoS management for data delivery. The PCRF performs, for example, QoS management for a communication path between the UE_A 10 and the PDN. Furthermore, the PCRF may be an apparatus that creates and/or manages a Policy and Charging Control (PCC) rule and/or a routing rule that each apparatus uses in a case of transmitting and/or receiving user data.

The HSS is connected to the MME and/or the SCEF and has a function such as a function of managing subscriber information. The subscriber information of the HSS is referred to, for example, in a case of access control of the MME. Furthermore, the HSS may be connected to a location management apparatus different from the MME.

### 3. Description of Terms and Identification Information Used in Each Embodiment

Next, terms and identification information used in each embodiment will be described in advance.

### 3.1. Description of Terms Used in Each Embodiment

Now, highly technical terms and identification information used in procedures which will be used in the embodiments will be described.

A network refers to at least some of the access network_B, the core network_B, and the DN. One or more apparatuses included in at least a part of the access network_B, the core network_B, and the DN may be referred to as a network or a network apparatus. In other words, “a network transmits and/or receives a message and/or performs processing” may mean “an apparatus (a network apparatus and/or a control apparatus) in the network transmits and/or receives the message and/or performs the processing”. Conversely, “an apparatus in a network transmits and/or receives a message and/or performs processing” may mean “the network transmits and/or receives the message and/or performs the processing”.

A session management (SM) message (also referred to as a Non-Access-Stratum (NAS) SM message) may be a NAS message used in a procedure for SM, or may be a control message transmitted and/or received between the UE_A 10 and the SMF_A 230 via the AMF_A 240. Furthermore, the SM message may include a PDU session establishment request message, a PDU session establishment accept message, a PDU session reject message (PDU session establishment reject message), a PDU session modification request message, a PDU session modification command message, a PDU session modification completion message (PDU session modification complete), a PDU session modification command reject message, a PDU session modification reject message, a PDU session release request message, a PDU session release reject message, a PDU session release command message, a PDU session release complete message, and the like. The procedure for SM or the SM procedure may include a PDU session establishment procedure, a PDU session modification procedure, and a PDU session release procedure (UE-requested PDU session release procedure). Note that each procedure may be a procedure initiated by the UE or may be a procedure initiated by the NW.

A Mobility management (MM) message (also referred to as a NAS MM message) may be a NAS message used in a procedure for MM, or may be a control message transmitted and/or received between the UE_A 10 and the AMF_A 240. Furthermore, the MM message may include a Registration request message, a Registration accept message, a Registration reject message, a De-registration request message, a De-registration accept message, a configuration update command message, a configuration update complete message, a Service request message, a Service accept message, a Service reject message, a Notification message, a Notification response message, and the like. The procedure for MM or the MM procedure may include a Registration procedure, a De-registration procedure, a Generic UE configuration update procedure (which will also be referred to simply as a “UE configuration update procedure”), an authentication and/or authorization procedure, a Service request procedure, a Paging procedure, and a Notification procedure.

A 5G System (5GS) service may be a connection service provided using the core network_B 190. In addition, the 5GS service may be a service different from an EPS service, or may be a service similar to the EPS service.

A non 5GS service may be a service other than the 5GS service and may include an EPS service and/or a non EPS service.

A Packet Data Network (PDN) type indicates a type of PDN connection and includes IPv4, IPv6, IPv4v6, and non-IP. In a case that IPv4 is specified, it indicates that transmission and/or reception of data is performed using IPv4. In a case that IPv6 is specified, it indicates that transmission and/or reception of data is performed using IPv6. In a case that IPv4v6 is specified, it indicates that transmission and/or reception of data is performed using IPv4 or IPv6. In a case that non-IP is specified, it indicates that communication is performed using a communication method other than the IP, not communication using the IP.

Although a Protocol Data Unit/Packet Data Unit (PDU) session can be defined as a relationship between the DN that provides a PDU connectivity service and the UE, the PDU session may be connectivity established between the UE and an external gateway. In the 5GS, the UE establishes a PDU session via the access network_B and the core network_B, and can thereby perform transmission and/or reception of user data to and/or from the DN by using the PDU session. Here, the external gateway may be a UPF, an SCEF, or the like. The UE can perform transmission and/or reception of user data to and/or from an apparatus deployed in the DN, such as an application server, by using the PDU session. Note that each apparatus (the UE, and/or the access network apparatus, and/or the core network apparatus) may associate one or more pieces of identification information with a PDU session for management Note that these pieces of identification information may include one or more of a DNN, a QoS rule, a PDU session type, application identification information, NSI identification information, access network identification information, and an SSC mode, and may further include other pieces of information. In addition, in a case that multiple PDU sessions are established, pieces of identification information associated with the PDU sessions may have the same or different details.

The Data Network Name (DNN) may be identification information for identifying the core network and/or an external network such as the DN. Further, the DNN can also be used as information for selecting a gateway such as a PGW/UPF connecting the core network_B 190. In addition, the DNN may correspond to an Access Point Name (APN).

A Protocol Data Unit/Packet Data Unit (PDU) session type indicates a type of PDU session and includes IPv4, IPV6, Ethernet, and Unstructured. In a case that IPv4 is specified, it indicates that transmission and/or reception of data is performed using IPv4. In a case that IPv6 is specified, it indicates that transmission and/or reception of data is performed using IPv6. In a case that Ethernet is specified, it indicates that transmission and/or reception of an Ethernet frame is performed. Ethernet may indicate that communication using the IP is not performed. In a case that Unstructured is specified, it indicates that data is transmitted and/or received to and/or from an application server in the DN or the like by using a Point-to-Point (P2P) tunneling technique. For the P2P tunneling technique, for example, a UDP/IP encapsulation technique may be used. Note that the PDU session type may include the IP, in addition to the above. The IP can be specified in a case that the UE can use both of IPv4 and IPv6.

The Public land mobile network (PLMN) is a communication network that provides mobile radio communication services. The PLMN is a network managed by an operator who is a network operator, and the operator can be identified by a PLMN ID. A PLMN that matches a Mobile Network Code (MNC) and a Mobile Country Code (MCC) of an International Mobile Subscriber Identity (IMSI) of the UE may be a Home PLMN (HPLMN). Furthermore, the UE may hold, in the USIM, an Equivalent HPLMN list for identifying one or multiple Equivalent HPLMNs (EPLMNs). A PLMN different from the HPLMN and/or the EPLMN may be a VPLMN (Visited PLMN). A PLMN with which the UE has successfully registered may be a Registered PLMN (RPLMN).

A tracking area is a single or multiple ranges that can be expressed using location information of the UE_A 10 managed by the core network. Note that the tracking area may include multiple cells. Furthermore, the tracking area may be a range in which a control message such as paging is broadcast, or may be a range in which the UE_A 10 can move without performing a handover procedure. Furthermore, the tracking area may be a routing area, may be a location area, or may be any area similar to these. The tracking area may be hereinafter a TA. The tracking area may be identified by a Tracking Area Identity (TAI) including a Tracking area code (TAC) and a PLMN.

The Registration area is a set of one or more TAs allocated to the UE by the AMF. Note that, while moving within one or multiple TAs included in a registration area, the UE_A 10 may be able to move without transmitting and/or receiving a signal for updating the tracking area. In other words, the registration area may be an information group indicating an area in which the UE_A 10 can move without performing a tracking area update procedure. The registration area may be identified by a TAI list configured by one or multiple TAIs.

A current TAI is a TAI broadcast by a selected PLMN in a cell in which the UE is located or camps. In a case that the cell is a satellite NG-RAN cell that broadcasts multiple TACs in the selected PLMN, the UE NAS layer may select the current TAI from multiple tracking area codes (TACs) in the selected PLMN.

Lists of 5GS forbidden tracking areas may be lists of 5GS forbidden tracking areas for roaming and/or lists of 5GS forbidden tracking areas for regional provision of service, which are stored by the UE not operating in the SNPN access operation mode (SNPN access operation mode). In other words, the UE not operating in the SNPN access operation mode must store a list of 5GS forbidden tracking areas for roaming and/or a list of 5GS forbidden tracking areas for regional provision of service. Furthermore, the UE needs to search for a suitable cell belonging to a TA not included in the list of 5GS forbidden tracking areas in the same PLMN.

Note that the UE is not allowed to request 5GS services other than emergency services in a case that the UE is in a cell of a TA that belongs to a list of 5GS forbidden tracking areas for regional provision of service.

The UE may store the forbidden tracking area ID (TAI) in a list of 5GS forbidden tracking areas for regional provision of service to prevent repeated attempts to access to cells in the forbidden tracking areas. Furthermore, the list of 5GS forbidden tracking areas for regional provision of service may be deleted in a case that the UE is powered off, a case that the SIM is removed, or deleted periodically (for a period ranging from 12 hours to 24 hours).

Information indicating the 5GS forbidden tracking areas for roaming may be included in information elements including one or multiple forbidden TAIs (Forbidden TAI(s), also referred to as “forbidden TAIs) for the list of “5GS forbidden tracking areas for roaming” (forbidden TAI(s) for the list of “5GS forbidden tracking areas for roaming” information elements (IE)) included in a message transmitted by the network, and transmitted to the UE.

The 5GS forbidden tracking areas for regional provision of service may be included in information elements including one or multiple forbidden TAIs for the list of 5GS forbidden tracking areas for regional provision of service (forbidden TAI(s) for the list of “5GS forbidden tracking areas for regional provision of service” information elements (IE)) included in a message transmitted by the network and may be transmitted to the UE.

A UE ID is information for identifying the UE. The UE ID may be a Subscription Concealed Identifier (SUCI), or a Subscription Permanent Identifier (SUPI), or a Globally Unique Temporary Identifier (GUTI), or an International Mobile Subscriber Identity (IMEI), or an IMEI Software Version (IMEISV), or a Temporary Mobile Subscriber Identity (TMSI), for example. Alternatively, the UE ID may be other information configured by an application or within the network. Moreover, the UE ID may be information for identifying the user.

A non-terrestrial network (NTN) is an NG-RAN including multiple gNBs, and may provide a non-terrestrial NR access to a UE by an NTN payload and an NTN gateway mounted on an NTN transmission means such as a satellite or a flying object installed in the outer space or in the air.

Here, the NTN payload is a network node that is mounted on a satellite or a high-altitude platform station and provides a function of connecting a service link and a feeder link. Furthermore, the NTN payload may be a Transport Network Layer (TNL) node.

An NTN Gateway is an earth station installed on the surface of the earth, and provides a connection to the NTN payload using a feeder link. Furthermore, the NTN gateway may be a Transport Network Layer (TNL) node.

In other words, for example, “NR connection via a satellite” (NR satellite access) by the UE may be an NR connection via a gNB including an artificial satellite (also simply referred to as a “satellite” in the present specification) with an NTN payload mounted and an NTN gateway. Furthermore, the UE may perform a procedure for registration with the network and/or establishment of a PDU session via the NR connection, and may further perform communication by using the PDU session established after completion of these procedures.

Here, in the present specification, communication via an NTN is also referred to as communication via NR satellite access, communication via satellite access, communication via an NTN, NTN communication, 5GSAT communication, satellite communication, or the like. NR connection via a satellite (i.e., NTN) is also referred to as NR satellite access, connection via a satellite, access via a satellite, satellite radio access, satellite access, or the like. NR satellite access may be 3GPP access.

A terrestrial network (TN) may provide terrestrial radio access to the UE by an access network configured by a base station installed on the ground and the like. The TN may be a terrestrial network, as opposed to the NTN, which is a non-terrestrial network using satellites. The access network installed and configured on the ground may be, for example, an NG-RAN configured with multiple gNBs, an E-UTRAN configured with multiple eNBs, or the like, but is not limited thereto.

Here, in the present specification, communication via a TN is also referred to as communication via NR terrestrial access, communication via a TN, TN communication, non-satellite communication, or the like, An NR connection via a TN is also referred to as NR terrestrial access, or connection or access via a non-satellite, non-satellite access, or the like.

A radio access technology (RAT) type of the satellite NG-RAN may be information used to identify or distinguish different types of satellite NG-RAN access in satellite NG-RAN access. The RAT type of the satellite NG-RAN may include, for example, “NR (LEO)”, “NR (MEO)”, “NR (GEO)”, and “NR (OTHERSAT)”. Here, “LEO” may mean a low earth orbit satellite, “MEO” may mean a middle earth orbit satellite, “GEO” may mean a geostationary earth orbit satellite, and “OTHERSAT” may mean other satellites.

Here, the access technology may be related to a PLMN or an SNPN. Furthermore, a PLMN or an SNPN may be capable of supporting multiple access technologies. Here, the UE may use information of an access technology to determine the type of radio communication carrier in a case of selecting a particular PLMN or SNPN.

The AMF may determine the RAT type of the NR satellite access, and in a case that the UE is accessing NR using satellite access, an indication indicating the type of NR satellite access may be provided on the N2 interface. In the serving PLMN, in order to implement efficient mobility restrictions for NR access, a TA in which a cell of each NR satellite RAT type is deployed needs to be different from a TA of another different satellite RAT type or a TA of the RAT type of terrestrial access. Further, the AMF can initiate deregistration of the UE in a case of receiving an N2 UE context release request with a cause value indicating that the UE is not in the PLMN serving area.

For example, the coverage of NR satellite access provided by MEO and LEO satellites or a satellite constellation is discontinuous, and such coverage is also referred to as discontinuous network coverage or discontinuous coverage. Here, the discontinuous coverage is caused by, for example, a fact that MEO and LEO satellites or a satellite constellation moves in time series with respect to a specific location on earth, leading to discontinuation of the coverage that can be provided by these satellites or the satellite constellation. Note that a geostationary satellite (GEO) can provide coverage for a specific time and location on earth, and thus a problem of discontinuous network coverage does not basically arise.

The UE connected to the network via the NR satellite access providing such discontinuous network coverage moves back and forth between the out-of-coverage area and the in-coverage area in time series. Thus, each apparatus of the UE and/or the network may support some or all of one or multiple functions including control, parameters, or procedures for supporting discontinuous network coverage provided by NR satellite access. Note that, here, the term “in-coverage” may mean coverage (area) in which the UE can communicate with a satellite, or may mean coverage (area) in which the UE can communicate via a satellite. The term “out-of-coverage” may mean coverage (area) in which the UE cannot communicate with a satellite, or may mean coverage (area) in which the UE cannot communicate via a satellite.

More specifically, the one or multiple functions including control, parameters, or procedures for supporting discontinuous network coverage provided by NR satellite access may include satellite coverage availability information, and/or a mobility pattern, and/or a UE out-of-coverage period (Unreachable period), and/or an Unreachability period, and/or overload control (which may be referred to as congestion control) in discontinuous coverage provided by NR satellite access, and/or a maximum waiting time for overload control in discontinuous coverage, and/or a discontinuous coverage wait timer value for overload control in discontinuous coverage, and/or a back-off timer in discontinuous coverage provided by the NR satellite access, and/or offset information of a timer in NR satellite access providing discontinuous coverage. This will be described below.

Satellite coverage availability information is location and time information related to the expected coverage availability of a satellite or a satellite constellation providing discontinuous coverage. In other words, the satellite coverage availability information may be information of a location or a time at which the UE is expected to be able to use satellite access provided by a satellite or a satellite constellation. That is, the satellite coverage availability information may be information indicating an expected in-coverage or out-of-coverage of the UE at the location and time indicated by the information. Note that, in the present specification, the satellite coverage availability information is also simply referred to as satellite coverage information.

The UE may use the satellite coverage availability information in order to support operations in discontinuous coverage in satellite access or satellite connection. Moreover, the satellite coverage availability information may be provided from an external server to the UE via a PDU session or a Short Message Service (SMS).

Moreover, the AMF may use the satellite coverage availability information in order to support satellite access or satellite connection of the UE in discontinuous coverage. Here, the satellite coverage availability information may be provided from Operation and Maintenance (O&M) or the AF. The satellite coverage availability information provided to the AMF describes the time at which and the location in which satellite coverage is expected to be available in a certain area. Moreover, the satellite coverage availability information need not be UE-specific information and may be applied to any UE in the affected area by the AMF.

Here, particularly, the low earth orbit (LEO) satellite and the middle earth orbit (MEO) satellite may provide discontinuous coverage, and may be able to provide NR satellite access to the UE on the ground at a specific time and location, i.e., discontinuously.

The satellite coverage availability information may include information indicating a time and a location at which each satellite is predicted to be able to provide NR satellite access to the UE on the ground. Alternatively, the satellite coverage availability information may include information indicating a time and a location at which each satellite can provide NR satellite access to the UE on the ground and a time and a location at which each satellite cannot provide NR satellite access to the UE on the ground. Note that it is needless to say that the UE on the ground is not intended to be limited to a UE that is strictly in contact with the ground surface, and includes a UE that is not in contact with the ground surface.

The mobility pattern is a concept that the AMF can use to characterize and optimize mobility of the UE, and is also referred to as a UE mobility pattern. Here, the AMF may determine or update the mobility pattern of the UE, based on the subscriber information (subscription) of the UE, statistics of the UE mobility, a network local policy, and UE assistance information, or any combination of those. Here, statistics information of the UE mobility (statistics of the UE mobility) may be a trajectory of past or expected movement of the UE. In a case that an NWDAF is deployed in the network, the statistics of the UE mobility may be an analysis (i.e., statistics or prediction) provided by the NWDAF,

Moreover, for example, the mobility pattern may be able to be used by the AMF for optimization of mobility support provided to the UE, such as registration area allocation.

The UE may be able to receive the mobility pattern determined by the AMF via the C-Plane or the U-plane using various procedures, or may store the received mobility pattern.

Note that the mobility pattern in the present specification may be a conventional mobility pattern, or may be a mobility pattern in consideration of discontinuous coverage provided by NR satellite access. In addition to the AMF, the UE may determine or update the mobility pattern.

The UE out-of-coverage period may be a period or time in which the UE is expected or assumed to be out of coverage in NR satellite access providing discontinuous coverage. Here, the UE out-of-coverage period may be determined based on the satellite coverage information and the UE mobility pattern. Furthermore, a UE out-of-coverage period may be determined by the UE, or may be determined by a network or each network apparatus. More specifically, for example, the UE out-of-coverage period determined by the UE may be transmitted to the network, and the network or each network apparatus may receive and store the UE out-of-coverage period. For example, the network or any network apparatus (e.g., AMF) may transmit the determined UE out-of-coverage period to the UE or the network or another network apparatus, and the UE or the network or another network apparatus may receive and store the UE out-of-coverage period. The UE out-of-coverage period is also referred to as a period in which the UE is out of coverage.

Here, the UE out-of-coverage period may be a period in which the UE is out of coverage, or may be a timer or a timer value corresponding to the period in which the UE is out of coverage. The UE out-of-coverage period may be an unreachability period, or may be a period indicated by the unreachability period or a corresponding timer or timer value. Furthermore, for example, the unreachability period may be a timer or a timer value included in an “unreachability period duration IE”. In a case that the UE out-of-coverage period is a timer or a timer value corresponding to a period in which the UE is out of coverage, the timer may be started in a case that the UE transitions to an out-of-coverage state or an idle state (idle mode).

For example, the UE may use an existing timer or a new timer different from the existing timer as the timer or the timer value corresponding to the UE out-of-coverage period. More specifically, for example, the UE out-of-coverage period may be a timer or a timer value included in a “UE out-of-coverage period duration information element (IE)”. Furthermore, the “UE out-of-coverage period duration IE” may be an existing timer or timer value (e.g., GPRS Timer 3 IE), or may be information indicating a new timer or a new timer value for 5GSAT communication. Note that, for example, in a case that the UE out-of-coverage period is an unreachability period, a timer or a timer value indicating a period corresponding to the UE out-of-coverage period may be included in the “UE out-of-coverage period duration IE” and/or the “unreachability period duration IE”.

In a case that the UE determines the UE out-of-coverage period, the UE may determine the UE out-of-coverage period based on the satellite coverage availability information and the UE mobility pattern provided from the network or the satellite coverage availability information and the UE mobility pattern held by the UE. For example, the UE may determine the UE out-of-coverage period based on satellite coverage availability information provided from the network and the UE mobility pattern provided from the network. Alternatively, for example, the UE may determine the UE out-of-coverage period based on the satellite coverage availability information provided from the network and the UE mobility pattern held by the UE. Alternatively, for example, the UE may determine the UE out-of-coverage period based on the satellite coverage availability information held by the UE and the UE mobility pattern held by the UE, while not limited thereto.

Furthermore, for example, in a case that the UE can determine the “UE out-of-coverage period”, and in a case that the UE determines to remain in the out-of-service state in a period indicated by the UE out-of-coverage period, the UE may perform a mobility registration update procedure before the start of the unreachability period. Furthermore, the UE requests a Mobile Initiated Connection Only (MICO) mode parameter, an extended DRX (eDRX) parameter in CM-IDLE, or other NAS timers taking into account the UE out-of-coverage period using the associated procedures, where the UE out-of-coverage period is not included in a case that the UE requests to use the MICO mode or eDRX. Alternatively, the UE may notify the network of the UE out-of-coverage period in a case that the UE is about to leave the satellite coverage, and may further perform the mobility registration update procedure in a case that the UE returns to the coverage using any access type.

The overload control in the discontinuous coverage provided by the NR satellite access is control and/or a function for avoiding an excessive signal load on the network in a case that a large number of UEs return again to the coverage of the NR satellite access from the outside of the coverage. Moreover, the overload control in the discontinuous coverage may be control using a maximum waiting time. The maximum waiting time may be a time until the UE that has returned to the coverage of the satellite access is allowed to start NAS signalling with the network, which is determined by the AMF. In other words, for overload control, the AMF may determine the maximum waiting time until the UE is allowed to start NAS signalling with the network. Here, the maximum waiting time may be referred to as a Disco wait range, for example.

More specifically, in overload control in discontinuous coverage using the maximum waiting time, the AMF first determines the maximum waiting time based on a network configuration, a priority user, or a priority service, and transmits the maximum waiting time to the UE during a registration procedure or a UE configuration update procedure. Next, in a case that the UE having received the maximum waiting time has already received the maximum waiting time for the same RAT type and PLMN, the UE may replace the stored maximum waiting time. Furthermore, the UE having received the maximum waiting time may select a random value with the maximum waiting time as an upper limit and determine a discontinuous coverage wait timer value.

Here, the discontinuous coverage wait timer may be a timer for restricting the UE from connecting to the network via the satellite access. Furthermore, the UE may run the discontinuous coverage wait timer based on the discontinuous coverage wait timer value determined by the UE.

In a case that the UE returns from the outside of the coverage of the NR satellite access to the inside of the coverage in the same radio access technology (RAT) type and PLMN, the UE starts the discontinuous coverage wait timer. Note that the UE running the discontinuous coverage wait timer shall not start NAS signalling for the RAT type and PLMN. By the above procedure and processing, a large number of UEs returning to the coverage run the discontinuous coverage wait timer with different random values, thereby controlling and reducing an excessive signal load on the network.

Here, the maximum waiting time determined by the AMF may be included in a Mobility Management (MM) message transmitted and/or received during an MM procedure and transmitted to the UE. More specifically, for example, the MM procedure in which the AMF transmits the maximum waiting time to the UE may be a registration procedure or a UE configuration update procedure. Furthermore, for example, the MM message in which the AMF includes the maximum waiting time may be, for example, a registration accept message, a registration reject message, or a configuration update command message. In other words, the maximum waiting time may be included in an MM message and transmitted from the AMF to the UE in an MM procedure such as a registration procedure or a UE configuration update procedure.

Furthermore, in a case that the UE receives a paging message and there is a pending emergency service or the UE enters a TAI outside the registration area, the UE may stop the discontinuous coverage waiting time timer and start NAS signalling.

The UE, the network, or each apparatus using the function related to the maximum waiting time may support the maximum waiting time. In other words, in a case that the UE, the network, or each apparatus supports the maximum waiting time, for example, the AMF may have a capability to determine the maximum waiting time, or the UE may have a capability to select or determine the discontinuous coverage wait timer from the received maximum waiting time. In other words, the UE, the network, or each apparatus supporting communication via the NR satellite access may support the maximum waiting time as a function for discontinuous coverage.

A back-off timer in the discontinuous coverage provided by the NR satellite access may be a timer provided by an AMF to the UE for preventing a start of mobile originated (MO) data transmission or signalling before the UE is about to go out of coverage.

In other words, the back-off timer in the satellite discontinuous coverage provided by the AMF to the UE may be a back-off timer started for the UE to end at the time that the UE goes inside of the coverage (that is, the coverage period of the NR satellite access) based on the satellite coverage availability information, and the UE running the timer may be prohibited from starting the transmission or signalling of MO data. In a case that the UE after the expiration of the timer is still in the same satellite communication area, the UE may start transmission or signalling of the MO data, or in a case that the UE has discovered a cell of another TN or NTN, the UE may stop the timer, get registered via a new access network, and transmit the MO data.

Note that the AMF having provided the back-off timer to the UE may initiate an AN release procedure. Furthermore, the back-off timer in the satellite discontinuous coverage may use an existing timer, or may be defined as a new timer and used.

The offset information of the timer in the NR satellite access providing discontinuous coverage may be information that is associated with a timer caused to run while the UE is within the coverage area or a timer caused to run while the UE is out of coverage area and indicates a value of a timer offset in consideration of the gap between the coverage recognized by the UE or the network based on the satellite coverage availability information and the physical coverage defined by movement of the UE, the satellite orbit, or the like. Note that, in the present specification, the offset information of the timer in the NR satellite access providing the discontinuous coverage is also referred to as offset information of a timer indicating a time or a period, timer offset information, a timer offset, offset information, simply an offset, or the like.

Here, the offset information may be information or a parameter pre-configured in the UE, determined by the UE, or determined by the network. More specifically, for example, the offset information may be information or a parameter pre-configured in the UE. Alternatively, the offset information may be information or a parameter determined by the network, transmitted to the UE, and stored by the UE after the reception. Alternatively, the offset information may be information or a parameter determined by the UE, transmitted to the network, and stored by the network or each apparatus.

Timer offset information may be related to one or multiple timers. That is, the timer offset information may be associated with the same number of pieces of offset information for each of one or more timers, or one piece of offset information may be associated with one or more timers. Here, the timer related to the offset information may be a period or a timer indicating a time during which the UE corresponding to the satellite coverage availability information is within the coverage, and/or information related to the UE out-of-coverage period. More specifically, for example, the offset information may be an offset value of a timer used to specify the time by which the start or end of the timer corresponding to a period in which the UE is out of or in the coverage is advanced or delayed in consideration of the discontinuous coverage in the NR satellite access. In other words, for example, in a case that the offset information is information indicating that the expiration time is extended for the timer corresponding to the UE out-of-coverage period, the UE may start the timer based on the value obtained by adding the value of the offset information to the timer value.

### 3.2. Description of Identification Information in Each Embodiment

First identification information in the present example may be identification information indicating that the network requests the UE to initiate the registration procedure for the network via satellite access in a case that the UE returns to the coverage from the outside of the coverage of the satellite access. In other words, it may be identification information indicating that the network requests or is requesting the UE that has returned to the coverage from the outside of the coverage of satellite access to initiate the registration procedure for the network via the satellite access. Here, the registration procedure that the UE that has returned to the coverage from the outside of the coverage of satellite access initiates for the network via the satellite access may be a registration update procedure.

The first identification information may be associated with or related to any one or more of a RAT type, and/or a PLMN, and/or an access type, and/or an area, and/or a core network or system type. Here, the area with which the first identification information is associated may be the registration area or the tracking area, for example. The core network/system with which the first identification information is associated may be the 5G Core Network (5GCN) or the 5G System (5GS), or the Evolved Packet Core (EPC) or the Evolved Packet System (EPS), for example. Here, the first identification information may be identification information including an association or information of the association of one or more of the RAT type, and/or the PLMN, and/or the access type, and/or the area, and/or the core network or system type. Alternatively, the UE may store the association or the association of one or more of the RAT type, and/or the PLMN, and/or the access type, and/or the area, and/or the core network or system type, together with the first identification information.

Alternatively, the first identification information may be identification information including information indicating that it is common to any one of the RAT type, and/or the PLMN, and/or the access type, and/or the area, and/or the core network or system type. More specifically, for example, the first identification information may be identification information including information indicating that it is common to a specific PLMN. In other words, for example, in a case that the first identification information includes information indicating that it is common to a specific PLMN, regarding the first identification information, the UE may perform a behavior based on the first identification information in the PLMN, regardless of the RAT type, and/or the access type, and/or the area, and/or the core network or system type.

Here, the UE may receive the first identification information via satellite access or terrestrial access, and may recognize that the first identification information is active in corresponding access and/or network based on the association or the information of the association of the RAT type, and/or the PLMN, and/or the access type, and/or the area, and/or the core network or system type included in the first identification information or the information indicating that it is common to any one of them, and perform a behavior based on the identification information.

The first identification information may be included in any one of messages in the registration procedure from the network via satellite access or the mobility management procedure initiated by the network, and transmitted to the UE. More specifically, the first identification information may be included in the registration accept message, and/or the configuration update command message, and/or the notification message, or the NAS transport message, and transmitted from the network to the UE via satellite access. Here, the registration accept message including the first identification information may be transmitted during the initial registration procedure or the registration update procedure.

As described above, for example, the first identification information may be identification information indicating a request to initiate the registration update procedure for the network via the satellite access in a case that the UE returns to the coverage of the satellite access from the outside of the coverage of the satellite access, and moreover the first identification information may be identification information related to the PLMN, and/or the RAT type, and/or the access type, and/or the area.

Here, in a case that the UE that has received the first identification information returns to the coverage through the outside of the coverage of satellite access in discontinuous satellite coverage, the UE may perform the registration update procedure based on the first identification information after expiration of the discontinuous coverage wait timer. In other words, the UE that has received the first identification information from the network and returns to the coverage from the outside of the satellite coverage need not initiate or perform the registration update procedure based on the first identification information while the discontinuous coverage wait timer is running.

The UE that has received the first identification information, or the UE that has received the first identification information, may perform the registration update procedure each time the UE returns to the coverage through the outside of the coverage of satellite access in discontinuous satellite coverage.

Here, for example, in a case that the UE returns to the coverage from the outside of the satellite coverage and any one or more of the RAT type, and/or the PLMN, and/or the access type, and/or the area, and/or the core network or system type in connection in a period in which the UE is in the coverage immediately before are different, the UE may stop the behavior based on the first identification information. In other words, for example, in a case that the connection is changed to connection with a combination different from that of the RAT type, and/or the PLMN, and/or the access type, and/or the area, and/or the core network or the system associated with first identification information #1, the UE need not perform the registration update procedure. In other words, in a case that the UE is in the coverage of the RAT type, and/or the PLMN, and/or the access type, and/or the area, and/or the core network or the system associated with first identification information #1, the UE may recognize that the first identification information is active and activate the first identification information. In a case of being in the coverage of a network different from that with the RAT type, and/or the PLMN, and/or the access type, and/or the area, and/or the core network or the system associated with first identification information #1, it may be recognized that the first identification information is inactive and may be deactivated.

More specifically, for example, in a case that a connection destination of the network to which the UE is connected via satellite access in a period in which the UE is in the coverage before going out of the coverage is the 5G Core Network (5GC) or the 5G System (5GS), and the connection destination in a case that the UE returns again to the coverage is switched to the Evolved Packet Core Network (EPC) or the Evolved Packet System (EPS), the registration update procedure based on the first identification information need not be initiated or performed. Additionally/alternatively, for example, in a case that the network to which the UE is connected via satellite access has the RAT type switched before and after the UE goes out of the coverage, the registration update procedure based on the first identification information need not be initiated or performed. Additionally/alternatively, for example, in a case that the network to which the UE is connected via satellite access has the PLMN switched before and after the UE goes out of the coverage, the registration update procedure based on the first identification information need not be initiated or performed. Additionally/alternatively, for example, in a case that the network to which the UE is connected via satellite access has the access type switched before and after the UE goes out of the coverage and the PLMN switched before and after the UE goes out of the coverage, the registration update procedure based on the first identification information need not be initiated or performed. Additionally/alternatively, for example, in a case that the network to which the UE is connected via satellite access has the area switched before and after the UE goes out of the coverage, the registration update procedure based on the first identification information need not be initiated or performed. Moreover, for example, in a case that the UE returns to the coverage from the outside of the satellite coverage and it is the RAT type, and/or the PLMN, and/or the access type, and/or the area, and/or the core network or the system associated with first identification information #1, the UE may perform the registration update procedure based on first identification information #1. In other words, the UE that has received the first identification information may perform the registration update procedure each time the UE returns to the coverage from the outside of the coverage of satellite access.

Moreover, the behavior based on the first identification information may be activated at the time point that the UE receives the first identification information and returns to the coverage through the outside of the coverage of satellite access. In other words, the UE that has received the first identification information may be activated from the time point that the UE next returns to the coverage through the outside of the coverage of satellite access due to discontinuous satellite coverage, and the registration update procedure may be performed. Additionally/alternatively, in a case that a condition such as a timing, and/or the number of times, and/or a period for activating the first identification information is included and indicated in the first identification information by the network, the UE may recognize that the first identification information is active in accordance with the information, and perform the behavior based on the first identification information. Additionally/alternatively, in a case that the UE transitions to the deregistered state, or the condition, such as the timing, and/or the number of times, and/or the period for activating the first identification information, that is included and indicated in the first identification information by the network ends or expires, the UE may recognize that the first identification information is deactivated.

The details of the behaviors of the UE and the network based on the first identification information will be further described in Section 5 as well. Note that the UE behavior based on the first identification information (also simply referred to as the behavior based on the first identification information) in the present specification may be a behavior of the UE that has received the first identification information from the network, or may be a behavior that the UE that has returned to the coverage through the outside of the coverage of satellite access performs the registration update procedure or the registration procedure via the satellite access based on the first identification information as described above. Moreover, the behavior based on the first identification information in the present specification may include a combination of multiple behaviors including the UE receiving the first identification information from the network, and/or the UE returning to the coverage from the outside of the coverage of satellite access, and/or the UE activating the first identification information, and/or the UE performing the registration update procedure or the registration procedure via satellite access based on the first identification information. Note that the behavior based on the first identification information in the present specification may indicate that the combination of these behaviors is performed once, for example. Moreover, the behavior based on the first identification information in the present specification may be performed by the UE one or more times in consideration of the condition of the behavior based on the first identification information, which is indicated as the information being further included in the first identification information or related to the first identification information, and transmitted by the network together with the first identification information, for example. In the present specification, in this case, the behavior based on the first identification information may be performed once or multiple times, or a combination of one or more of the behaviors each constituting the multiple times of the behaviors based on the first identification information in the behavior based on the first identification information may be performed.

Second identification information in the present example may be identification information indicating that the network requests the UE not to perform the registration update procedure for the network via satellite access in a case that the UE transitions or returns to the coverage from the outside of the coverage of the satellite access. Moreover, the second identification information may be identification information further transmitted from the network in a case that the UE receives the first identification information from the network.

The second identification information may be associated with or related to any one or more of a RAT type, and/or a PLMN, and/or an access type, and/or an area, and/or a core network or system type. Here, the area with which the second identification information is associated may be the registration area or the tracking area, for example. The core network/system with which the first identification information is associated may be the 5G Core Network (5GCN) or the 5G System (5GS), or the Evolved Packet Core (EPC) or the Evolved Packet System (EPS), for example. Here, the second identification information may be identification information including an association or information of the association of one or more of the RAT type, and/or the PLMN, and/or the access type, and/or the area, and/or the core network or system type. Alternatively, the UE may store the association or the association of one or more of the RAT type, and/or the PLMN, and/or the access type, and/or the area, and/or the core network or system type, together with the second identification information.

Alternatively, the second identification information may be identification information including information indicating that it is common to any one of the RAT type, and/or the PLMN, and/or the access type, and/or the area, and/or the core network or system type. More specifically, for example, the second identification information may be identification information including information indicating that it is common to a specific PLMN. In other words, for example, in a case that the second identification information includes information indicating that it is common to a specific PLMN, regarding the second identification information, the UE may perform a behavior based on the second identification information in the PLMN, regardless of the RAT type, and/or the access type, and/or the area, and/or the core network or system type.

Here, the UE may receive the second identification information via satellite access or terrestrial access, and may recognize that the second identification information is active in corresponding access and/or network based on the association or the information of the association of the RAT type, and/or the PLMN, and/or the access type, and/or the area, and/or the core network or system type included in the second identification information or the information indicating that it is common to any one of them, and perform a behavior based on the identification information.

The second identification information may be included in any one of messages in the registration procedure from the network via satellite access or the mobility management procedure initiated by the network, and transmitted to the UE. More specifically, the second identification information may be included in the registration accept message, and/or the configuration update command message, and/or the notification message, or the NAS transport message, and transmitted from the network to the UE via satellite access. Here, the registration accept message including the second identification information may be transmitted during the initial registration procedure or the registration update procedure.

More specifically, for example, the registration update procedure performed by the UE each time the UE returns to the coverage from the outside of the coverage of satellite access based on reception of the first identification information need not be performed after reception of the second identification information. In other words, the second identification information may be identification information for deactivating an operation of the UE based on the first identification information already received by the UE. Note that the second identification information for deactivating the first identification information needs to be associated with the same combination of any one or more of the RAT type, and/or the PLMN, and/or the access type, and/or the area, and/or the core network or system type as that of the first identification information.

The details of the behaviors of the UE and the network based on the second identification information will be further described in Section 5 as well.

Third identification information in the present example is identification information indicating that the network registered and/or connected by the UE via satellite access requests the UE to initiate the registration update procedure. Here, the UE that has received the third identification information may immediately perform the registration update procedure, based on the third identification information, for example. Alternatively, the UE may perform the registration update procedure based on the third identification information after the procedure being performed in a case of receiving the third identification information ends. Alternatively, the registration update procedure may be performed at a timing based on information further indicated from the network together with the third identification information.

The third identification information may be associated with or related to any one or more of a RAT type, and/or a PLMN, and/or an access type, and/or an area, and/or a core network or system type. Here, the area with which the third identification information is associated may be the registration area or the tracking area, for example. The core network/system with which the third identification information is associated may be the 5G Core Network (5GCN) or the 5G System (5GS), or the Evolved Packet Core (EPC) or the Evolved Packet System (EPS), for example.

Here, the third identification information may be identification information including an association or information of the association of one or more of the RAT type, and/or the PLMN, and/or the access type, and/or the area, and/or the core network or system type. Alternatively, the UE may store the association or the association of one or more of the RAT type, and/or the PLMN, and/or the access type, and/or the area, and/or the core network or system type, together with the third identification information.

Alternatively, the third identification information may be identification information including information indicating that it is common to any one of the RAT type, and/or the PLMN, and/or the access type, and/or the area, and/or the core network or system type. More specifically, for example, the third identification information may be identification information including information indicating that it is common to a specific PLMN. In other words, for example, in a case that the third identification information includes information indicating that it is common to a specific PLMN, regarding the third identification information, the UE may perform a behavior based on the third identification information in the PLMN, regardless of the RAT type, and/or the access type, and/or the area, and/or the core network or system type.

Here, the UE may receive the third identification information via satellite access or terrestrial access, and may recognize that the third identification information is active in corresponding access and/or network based on the association or the information of the association of the RAT type, and/or the PLMN, and/or the access type, and/or the area, and/or the core network or system type included in the third identification information or the information indicating that it is common to any one of them, and perform a behavior based on the identification information.

In other words, for example, the UE that has received the third identification information may initiate the registration update procedure for the network that has transmitted the third identification information via satellite access used to receive the third identification information. More specifically, for example, the UE may perform the registration procedure via connection of a combination of one or more of the RAT type, and/or the PLMN, and/or the access type, and/or the area, and/or the core network or system type used to receive the third identification information. Conversely, for example, the UE need not perform the registration update procedure based on the third identification information via connection of a combination of one or more of the RAT type, and/or the PLMN, and/or the access type, and/or the area, and/or the core network or system type used to receive the third identification information.

The third identification information may be included in any one of messages in the registration procedure from the network via satellite access or the mobility management procedure initiated by the network, and transmitted to the UE. More specifically, the third identification information may be included in the registration accept message, and/or the configuration update command message, and/or the notification message, or the NAS transport message, and transmitted from the network to the UE via satellite access. Here, the registration accept message including the third identification information may be transmitted from the network to the UE during the initial registration procedure or the registration update procedure.

In a case that the UE is in the coverage of satellite access used in connecting the network or during a period thereof, the network may transmit a message including the third identification information to the UE or initiate or perform a procedure for transmitting the message at any timing.

The third identification information may be identification information transmitted and/or received independently of transmission and/or reception of the first identification information and/or the second identification information. In other words, for example, the third identification information may be identification information that the network can transmit to the UE at any timing, regardless of whether or not the first identification information and/or the second identification information is transmitted from the network to the UE.

The details of the behaviors of the UE and the network based on one or a combination of the first identification information to the third identification information described above are not limited to those described in this section, and will be further described in Section 5 as well.

### 4. Description of Procedures Used in Each Embodiment

Next, procedures used in each embodiment will be described. Here, the procedures used in each embodiment may include the Registration procedure and the mobility management procedure initiated by the network.

Note that, in each embodiment, a case that each of the HSS and the UDM, the PCF and the PCRF, the SMF and the PGW-C, and the UPF and the PGW-U is configured as a single apparatus (that is, the same physical hardware, or the same logical hardware, or the same software) as illustrated in FIG. 2 will be described as an example. However, the details described in the present embodiment can also be applied to a case that each of the combinations is configured as different apparatuses (that is, different pieces of physical hardware, or different pieces of logical hardware, or different pieces of software). For example, between the apparatuses/functions, data may be directly transmitted and/or received, data may be transmitted and/or received via an N26 interface between the AMF and the MME, or data may be transmitted and/or received via the UE.

The details of each procedure will be described below.

### 4.1. Registration Procedure

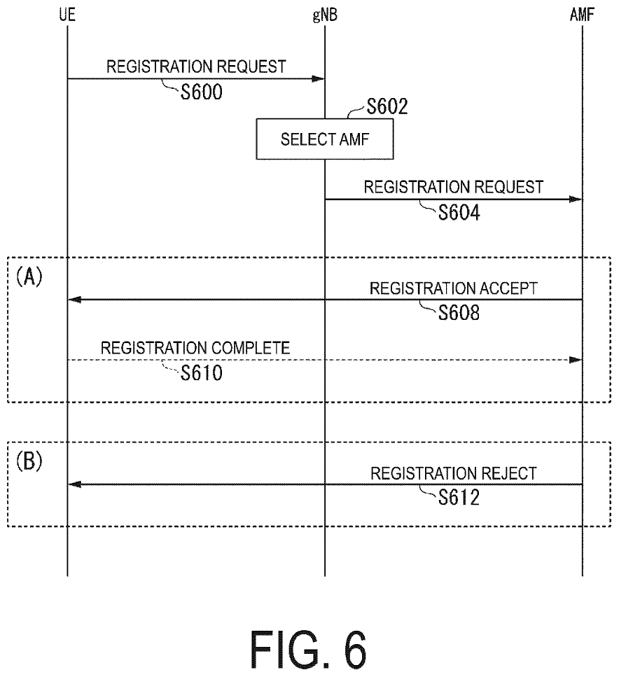

First, the Registration procedure will be described with reference to FIG. 6. The registration procedure is a procedure in the 5GS. Hereinafter, the registration procedure will be referred to as the present procedure in this subsection. The registration procedure is a procedure for registration with the access network_B, and/or the core network_B, and/or the DN initiated by the UE. In a case that the UE is in a state of not being registered with the network, for example, the UE can perform the present procedure at any timing, for example, a power input time. In other words, the UE can initiate the present procedure at any timing as long as the UE is in a deregistered state (an RM-DEREGISTERED state). Each of the apparatuses (especially, the UE and the AMF) can transition to a registered state (an RM-REGISTERED state) based on completion of the Registration procedure.

The registration procedure may be an initial registration initiated by the UE. The registration procedure may be mobility and periodic registration. The registration procedure may be the MM procedure.

In addition, the registration procedure may be a procedure for updating location registration information of the UE on the network, and/or periodically provide notification of the state of the UE from the UE to the network, and/or updating a specific parameter related to the UE on the network.

The present procedure may be a procedure for registration by the UE via NR satellite access. A PDU session established after completion of the present procedure may be a PDU session via the satellite NG-RAN or the NR satellite access. In other words, a PDU session established through a PDU session establishment procedure performed after the registration procedure is completed through the NR satellite access may be a PDU session via the NR satellite access. Alternatively, for example, a PDU session through the NR satellite access may be established based on completion of the present procedure.

The UE may initiate a registration procedure in a case that the UE has performed mobility across a TA. More specifically, in a case that the UE moves to a TA different from the TA indicated by the TA list held by the UE, the UE may initiate the mobility registration update procedure to perform re-registration. In addition, the UE may initiate the present procedure in a case that a running timer expires. Furthermore, the UE may initiate the registration procedure in a case that a context of each apparatus needs to be updated due to disconnection and/or deactivation of a PDU session. Furthermore, in a case that there has been a change in capability information and/or a preference, related to PDU session establishment of the UE, the UE may initiate the registration procedure. In addition, the UE may periodically initiate the registration procedure. Furthermore, the UE may initiate a registration procedure based on completion of a UE configuration update procedure. Note that the UE is not limited to this configuration, and can perform the registration procedure at any timing.

Furthermore, the UE may initiate the registration procedure periodically even in a registered state. In other words, the UE may initiate a registration procedure based on expiration of a timer. In other words, the registration procedure performed periodically may be a periodic registration update procedure.

Note that the registration procedure performed based on the mobility of the UE and the registration procedure performed periodically may be expressed as a registration procedure for mobility and registration update. In other words, the registration procedure for mobility and registration update may be a registration procedure performed based on the mobility of the UE or may be a registration procedure performed periodically. Furthermore, the registration procedure for mobility and registration update may be a registration procedure performed based on configuration update of the UE. Furthermore, the registration procedure for mobility and registration update may be a registration procedure performed to establish a communication path for transmitting and/or receiving user data. Furthermore, the registration procedure for mobility and registration update may be a registration procedure performed based on a request from the network. In other words, the registration procedure for mobility and registration update may be a registration procedure other than an initial registration procedure. Hereinafter, the registration procedure for mobility and registration update may be referred to as the present procedure. In the present specification, the registration update procedure initiated or performed by the UE may be the registration procedure, i.e., the registration update procedure in the present specification may be interpreted as the registration procedure, for example.

Next, each step of the registration procedure will be described. The registration procedure described below may be an initial registration procedure or a registration procedure for mobility and registration update.

First, the UE initiates the registration procedure by transmitting a registration request message to the AMF (S600), (S602), and (S604). Specifically, the UE transmits an RRC message including the registration request message to the 5G AN (or the gNB) (S600). Note that the registration request message is a NAS message. The RRC message may be a control message transmitted and/or received between the UE and the 5G AN (or the gNB). The NAS message is processed in the NAS layer, and the RRC message is processed in the RRC layer. Note that the NAS layer is a layer higher than the RRC layer.

Here, the UE may include, in the registration request message, identification information indicating that the UE supports various functions for communication via NR satellite access, and transmit the registration request message. Here, the identification information indicating that the UE supports various functions for communication via NR satellite access may be information included in a 5GMM capability information element indicating that the UE supports various functions for communication via NR satellite access.

The UE may initiate the PDU session establishment procedure during the registration procedure by including and transmitting the SM message in the registration request message or by transmitting the SM message along with the registration request message. Here, the SM message may be a PDU session establishment request message.

In a case that the 5G AN (or the gNB) receives the RRC message including the registration request message, then the 5G AN (or the gNB) selects the AMF to transfer the registration request message (S602). Note that the 5G AN (or the gNB) can select an AMF based on information included in the registration request message and/or the RRC message. The 5G AN (or the gNB) extracts the registration request message from the received RRC message and transfers the registration request message to the selected AMF (S604).

The AMF may perform a first condition fulfillment determination in a case that the AME has received a registration request message. The first condition fulfillment determination is used by the network (or AMF) to determine whether to accept the request of the UE. In a case that the first condition fulfillment determination is true, the AMF initiates the procedure of (A) of FIG. 6, whereas in a case that the first condition fulfillment determination is false, the AMF initiates the procedure of (B) of FIG. 6.

Note that the first condition fulfillment determination may be performed based on reception of the registration request message, and/or each piece of identification information included in the registration request message, and/or subscriber information, and/or network capability information, and/or an operator policy, and/or a network state, and/or user registration information, and/or a context held by the AMF, and/or the like. For example, the first condition fulfillment determination may be true in a case that the network allows the request from the UE, and the first condition fulfillment determination may be false in a case that the network does not allow the request from the UE. In a case that a network with which the UE is to be registered and/or an apparatus in the network supports the function requested by the UE, the first condition fulfillment determination may be true, whereas in a case that the network and/or the apparatus does not support the function requested by the UE, the first condition fulfillment determination may be false. Furthermore, in a case that the transmitted and/or received identification information is allowed, the first condition fulfillment determination may be true, whereas in a case that the transmitted and/or received identification information is not allowed, the first condition fulfillment determination may be false. Note that the conditions for determining whether the first condition fulfillment determination is true or false may not be limited to the conditions described above.

First, the case that the first condition fulfillment determination is true will be described. In the procedure of (A) of FIG. 6, first, the AMF can perform the fourth condition fulfillment determination. The fourth condition fulfillment determination is used by the AMF to determine whether to transmit and/or receive an SM message to and/or from an SMF.

The fourth condition fulfillment determination may be made based on whether the AMF has received an SM message. The fourth condition fulfillment determination may be made based on whether an SM message is included in the registration request message. For example, the fourth condition fulfillment determination may be true in a case that the AMF has received an SM message and/or in a case that an SM message is included in the registration request message and false in a case that the AMF has received no SM message and/or in a case that no SM message is included in the registration request message. Note that the conditions for determining whether the fourth condition fulfillment determination is true or false may not be limited to the conditions described above.

Next, based on the reception of the registration request message and/or the completion of transmission and/or reception of the SM message to and/or from the SMF, the AMF transmits a registration accept message to the UE via the 5G AN (or the gNB) as a response message to the registration request message (S608). For example, in a case that the fourth condition fulfillment determination is false, the AMF may transmit a registration accept message based on receiving the registration request message from the UE. In a case that the fourth condition fulfillment determination is true, the AMF may transmit a registration accept message based on completion of transmission and/or reception of an SM message to and/or from the SMF. Note that the registration accept message is a NAS message transmitted and/or received over the NI interface, but is included in an RRC message and transmitted and/or received between the UE and the 5G AN (the gNB).

The AMF may include and transmit, in the registration accept message, the first identification information and/or the second identification information. More specifically, for example, in a case that the first identification information and/or the second identification information is associated with the same combination of any one or more of the RAT type, and/or the PLMN, and/or the access type, and/or the area, and/or the core network or system type, the AMF may include, in the registration accept message, any one of the first identification information or the second identification information, and receive the registration accept message to the UE. More specifically, for example, the AMF need not include the first identification information associated with a combination of {RAT type #1, PLMN #1} and the second identification information associated with a combination of {RAT type #1, PLMN #1} in the same registration accept message.

Conversely, for example, in a case that the first identification information and/or the second identification information is associated with a different combination of any one or more of the RAT type, and/or the PLMN, and/or the access type, and/or the area, and/or the core network or system type, the AMF may include, in the same registration accept message, the first identification information or the second identification information, and transmit the same registration accept message to the UE. More specifically, for example, the AMF may include, in the same registration accept message, the first identification information associated with a combination of {RAT type #1, PLMN #2} and the first identification information associated with a combination of {RAT type #2, PLMN #1}, and transmit the same registration accept message to the UE.

By transmitting the first identification information and/or the second identification information, the AMF may indicate the content of the first identification information and/or the second identification information to the UE. Moreover, the UE that has received the first identification information and/or the second identification information may store the received identification information, or may behave based on the content of the received identification information. Detailed behaviors of the UE that has received the first identification information and/or the second identification information will be described in Section 5.

In a case that multiple pieces of identification information are transmitted and/or received, two or more pieces of identification information of these pieces of identification information may be configured as one or more pieces of identification information. Note that information indicating support for each function and information indicating a request to use each function may be transmitted and/or received with the same piece of identification information or may be transmitted and/or received as different pieces of identification information.

Note that the AMF may select or determine whether or not to include the first identification information and/or the second identification information in the registration accept message, based on each piece of identification information received by the AMF from the UE or each apparatus, and/or subscriber information, and/or network capability information, and/or an operator policy, and/or a network state, and/or user registration information, and/or a context held by the AMF, and/or the like.

The AMF can include and transmit the SM message in the registration accept message or transmit the SM message along with the registration accept message. However, this transmission method may be performed in a case that the SM message may be included in the registration request message and the fourth condition fulfillment determination is true. This transmission method may be performed in a case that the SM message is included with the registration request message and the fourth condition fulfillment determination is true. By performing such a transmission method as described above, the AMF can indicate that a procedure for SM has been accepted in the registration procedure. Here, the SM message may be a PDU session establishment request message or may be a PDU session establishment accept message.

The AMF may indicate that the request of the UE has been accepted by transmitting the registration accept message, based on each piece of received identification information, and/or subscriber information, and/or network capability information, and/or an operator policy, and/or a network state, and/or user registration information, and/or a context held by the AMF, and/or the like.

Furthermore, the AMF may include and transmit, in the registration accept message, information indicating that a part of the request of the UE has been rejected or may transmit information indicating that a part of the request of the UE has been rejected to indicate a cause for a part of the request of the UE being rejected. Furthermore, the UE may recognize a cause for a part of the request of the UE being rejected by receiving information indicating that a part of the request of the UE has been rejected. Note that the cause for rejection may be information indicating that content indicated by the identification information received by the AMF is not allowed.

The UE receives the registration accept message from the AMF via the 5G AN (the gNB) (S608). By receiving the registration accept message, the UE can recognize that the request of the UE in the registration request message has been accepted and the content of various identification information included in the registration accept message.

Here, the UE that has received the registration accept message may recognize that the network holds a part or all of 5GSAT communication capabilities based on one or more received pieces of second identification information and store it.

Furthermore, the UE can further transmit a registration complete message to the AMF via the 5G AN (gNB) as a response message to the registration accept message (S610). Here, although the registration complete message is a NAS message transmitted and/or received over the N1 interface, the registration complete message is transmitted and/or received between the UE and the 5G AN (gNB) by being included in an RRC message.

The AMF receives the registration complete message via the 5G AN (the gNB) (S610), Each apparatus completes the procedure of (A) of FIG. 6, based on transmission and/or reception of the registration accept message and/or the registration complete message.

Next, the case that the first condition fulfillment determination is false will be described. In the procedure (B) of FIG. 6, the AMF transmits a registration reject message to the UE via the 5G AN (gNB) as a response message to the registration request message (S612). Here, the registration reject message is a NAS message transmitted and/or received over the N1 interface, but is included in an RRC message and transmitted and/or received between the UE and the 5G AN (the gNB).

Here, the AMF may include and transmit one or more pieces of second identification information in the registration reject message. By the AMF transmitting these pieces of identification information, the AMF may indicate to the UE that the network does not hold a part or all of 5GSAT communication capabilities. Moreover, the AMF may include a reject cause value indicating no possession of a part or all of 5GSAT communication capabilities, or a reject cause value corresponding to a 5GSAT communication function not supported by the network.

In a case that multiple pieces of identification information are transmitted and/or received, two or more pieces of identification information of these pieces of identification information may be configured as one or more pieces of identification information. Note that information indicating support for each function and information indicating a request to use each function may be transmitted and/or received with the same piece of identification information or may be transmitted and/or received as different pieces of identification information.

Note that the AMF may select or determine whether or not to include the second identification information in the registration reject message, based on each piece of identification information received by the AMF, and/or subscriber information, and/or network capability information, and/or an operator policy, and/or a network state, and/or user registration information, and/or a context held by the AMF, and/or the like.

Furthermore, the AMF may transmit a registration reject message to indicate that the request of the UE in the registration request message has been rejected. Furthermore, the AMF may include and transmit, in a registration reject message, information indicating a cause for rejection or may transmit a reason for rejection to indicate the reason for rejection. Furthermore, the UE may recognize a cause for the request of the UE being rejected by receiving information indicating the reason why the request of the UE has been rejected. Note that the cause for rejection may be information indicating that content indicated by the identification information received by the AMF is not allowed.

The UE receives the registration reject message from the AMF via the 5G AN (gNB) (S612). By receiving the registration reject message, the UE can recognize that the request of the UE in the registration request message has been rejected and the content of various identification information included in the registration reject message. The UE may recognize that the request of the UE has been rejected in a case that the UE does not receive a registration reject message even in a case that a prescribed period of time has elapsed after transmitting a registration request message. Each apparatus completes the procedure (B) in the present procedure based on transmission and/or reception of the registration reject message.

Here, the UE that has received the registration reject message may recognize that the network does not hold a part or all of 5GSAT communication capabilities based on the received second identification information and store it.

Note that the procedure of (B) of FIG. 6 may be initiated in a case that the procedure of (A) of FIG. 6 is cancelled.

Each apparatus completes the registration procedure, based on completion of the procedure of (A) or (B) of FIG. 6. Note that each apparatus may transition to a state (RM_REGISTERED state) in which the UE is registered with the network, based on completion of the procedure of (A) of FIG. 6, may maintain a state (RM_DEREGISTERED state) in which the UE is not registered with the network or may transition to a state in which the UE is not registered with the network, based on completion of the procedure of (B) of FIG. 6. The transition of each apparatus to each state may be performed based on completion of the registration procedure or may be performed based on establishment of a PDU session.

The UE may complete the registration procedure based on reception of the registration accept message or the registration reject message.

Furthermore, each apparatus may perform processing based on information transmitted and/or received in the registration procedure, based on completion of the registration procedure. For example, in a case that information indicating that a part of the request from the UE has been rejected is transmitted and/or received, the cause for rejection of the request from the UE may be recognized. Furthermore, each apparatus may perform the present procedure again or may perform a registration procedure with the core network_B or another cell based on the cause for the request of the UE being rejected.

Moreover, the UE may store the identification information received along with the registration accept message and/or the registration reject message or may recognize determination of the network based on the completion of the registration procedure.

By receiving the registration accept message or the registration reject message, the UE may recognize the content of the identification information.

Note that the behavior performed in a case of receiving each piece of identification information may be performed based on the received identification information.

### 4.2. Mobility Management Procedure Initiated by Network

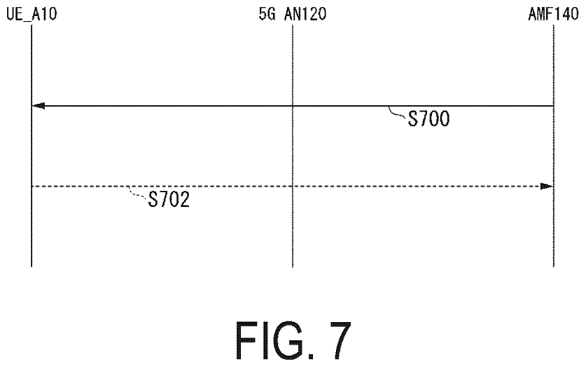

Next, the mobility management procedure initiated by the network will be described with reference to FIG. 7. In this subsection, the mobility management procedure initiated by the network is hereinafter also referred to as the present procedure. Here, the mobility management procedure initiated by the network is also referred to as a network-initiated mobility management procedure, an NW-init MM procedure, or the like.

The network-initiated mobility management procedure described in this section is the Generic UE configuration update procedure (also simply referred to as the UE configuration update procedure), or the Notification procedure, or the NAS transport (network-initiated NAS transport) procedure initiated by the network, or the Paging procedure. Here, the paging procedure may be a procedure for transferring Paging information to the UE in RRC_IDLE or RRC_INACTIVE. In other words, it may be a procedure performed in a case that the UE is in RRC_IDLE or RRC_INACTIVE.

First, the present procedure may be initiated by the AMF transmitting a message to the UE (S700), based on determination of the AMF or the core network apparatus. Here, the message transmitted by the AMF to the UE via NR satellite access may be the NAS message or the paging message. Note that, in a case that the present procedure is initiated based on determination of a core network apparatus other than the AMF or transmission of the message, the message transmitted by the core network apparatus may be transmitted to the UE via the AMF and NR satellite access.

Here, the message transmitted by the AMF to the UE (S700) may be the configuration update command message, and/or the Notification message, and/or the DL NAS TRANSPORT message, and/or the Paging message, but is not limited to these.

Moreover, the AMF may include, in the message transmitted in S700, one or more pieces of the first identification information to the third identification information, and transmit the message to the UE.

Next, the UE that has received the message transmitted by the AMF (S700) may or may not transmit a response message for the received message to the AMF via NR satellite access (S702).

Here, the transmitting by the UE to the AMF (S702) may be the configuration update complete message, or the Notification Response message, or the Service Request message, or the Registration Request message. Moreover, the message transmitted by the UE in S702 is not limited to these, and may be a response message corresponding to the message received by the UE, or a response message based on the identification information included in the message received by the UE.

Note that the present procedure may complete based on the UE receiving the message transmitted by the AMF via NR satellite access (S700), and/or the UE transmitting the response message to the AMF via NR satellite access based on the UE receiving the message in S700 (S702).

Note that the present procedure may be a procedure used by the network to transmit one or more pieces of the first identification information to the third identification information to the UE connected via satellite access. Moreover, the present procedure may be a procedure performed in a case that the AMF or the core network determines to transmit one or more pieces of the first identification information to the third identification information to the UE connected via satellite access.

### 5. Embodiments

Next, each embodiment in the present example will be described. Note that each embodiment described below in this section is based on definitions of terms, various pieces of identification information, or each behavior described in Section 3 and each procedure or each behavior described in Section 4.

Each embodiment may be an embodiment initiated in a state in which the UE connects to the network via NR satellite access and completes registration. In each embodiment or the present specification, the registration update procedure initiated or performed by the UE may be the registration procedure. In other words, for example, the registration update procedure initiated or performed by the UE in each embodiment or the present specification may be interpreted as the registration procedure.

Unless otherwise specified, the embodiments in the present example are not limited to individually and independently implementing the embodiments described in each subsection of this section, and may be implemented as a combination of one or more embodiments described in each subsection, or one or more embodiments described in each subsection may be implemented in no particular order.

Each embodiment will be described below.

### 5.1. First Embodiment

A first embodiment in the present example will be described. In this subsection, the first embodiment is hereinafter also referred to as the present embodiment.

First, the UE of the first embodiment receives a message including the first identification information from the network via satellite access.

More specifically, for example, the UE of the first embodiment receives the message including the first identification information from the network via satellite access during the mobility management procedure initiated by the network or during the registration procedure. Here, the first identification information may be included in the configuration update command message or the registration accept message and transmitted from the network to the UE via satellite access. More specifically, for example, the UE may receive the configuration update command message including the first identification information or the registration accept message including the first identification information from the AMF via satellite access.

In other words, the network or the AMF transmits the message including the first identification information via satellite access during the mobility management procedure initiated by the network or during the registration procedure. Here, by the network or the AMF, the first identification information may be included in the configuration update command message or the registration accept message, and transmitted from the network to the UE. More specifically, for example, the network or the AMF may transmit the configuration update command message including the first identification information or the registration accept message including the first identification information to the UE via satellite access.

Moreover, the UE that has received the first identification information from the network via satellite access may store the received first identification information. Moreover, in a case that the UE receives new first identification information, the UE may replace the already received and stored first identification information with the new received first identification information.

Next, in a case that the UE that has received the first identification information from the network goes out of the coverage of satellite access and then returns to the coverage in discontinuous satellite coverage, the UE may initiate or perform the registration update procedure for the network via the satellite access, based on the first identification information.

Here, the access and the network for which the UE performs the registration update procedure may be the satellite access and the network from which the UE has received the first identification information. Here, the network that has transmitted the message including the first identification information to the UE may be the network with which the UE has initially registered. Moreover, the first identification information received by the UE may be related to the PLMN of the network of a transmission source and the RAT type of the satellite access, for example.

Moreover, in a case that the UE returns to the coverage of satellite access and the discontinuous coverage wait timer is running, the UE need not perform the registration update procedure. In other words, for example, in a case that the UE returns to the coverage of satellite access and the discontinuous coverage wait timer is running, the UE may wait for expiration of the timer and perform the registration update procedure after expiration of the timer.

Note that, here, the UE that has received the first identification information may repeatedly perform the registration update procedure each time the UE returns to the coverage from the outside of the coverage of satellite access, and for example, the UE may perform the registration update procedure based on the first identification information and repeatedly perform the operation in the network with which the UE registers until the UE transitions to the deregistered state.

Alternatively, the UE that has received the first identification information repeatedly performs the registration update procedure each time the UE returns to the coverage from the outside of the coverage of satellite access, and in a case that any one or more of the RAT type, and/or the PLMN, and/or the access type, and/or the area, and/or the core network or system type are changed, the UE may stop performing the registration update procedure based on the first identification information and repetitions of the operation.

Alternatively, the UE that has received the first identification information repeatedly performs the registration update procedure each time the UE returns to the coverage from the outside of the coverage of satellite access, and in a case that any one or more of the RAT type, and/or the PLMN, and/or the access type, and/or the area, and/or the core network or system type are changed, the UE may stop performing the registration update procedure based on the first identification information and repetitions of the operation; however, in a case that the UE returns again to the coverage with the RAT type, and/or the PLMN, and/or the access type, and/or the area, and/or the core network or system type, and/or the access, and/or the network associated with the first identification information, the UE may again perform the registration update procedure based on the first identification information and perform repetitions of the operation.

Note that the change of the core network or the system in a case that the UE returns to the coverage from the outside of the coverage of satellite access may be a change from the 5G Core Network (5GCN) or the 5G System (5GS) to the Evolved Packet Core (EPC) or the Evolved Packet System (EPS), and in a case that the core network or the system is changed, the UE need not initiate or perform the registration update procedure based on the first identification information.

Moreover, the behavior based on the first identification information may be activated at the time point that the UE receives the first identification information and returns to the coverage through the outside of the coverage of satellite access. In other words, the first identification information may be activated from the time point that the UE that has received the first identification information next returns to the coverage of satellite access through the outside of the coverage of the satellite access, and the registration update procedure may be performed by the UE for the network via the satellite access, based on the first identification information.

Moreover, the network may further include, in the first identification information, information indicating a condition in a case that the UE performs the behavior of the UE based on the first identification information, or a request from the network, or a condition for activating or deactivating the first identification information, or the like in the first identification information, and transmit the information to the UE, or may transmit the information to the UE as information different from the first identification information. More specifically, the condition in a case that the UE performs the behavior of the UE based on the first information or the request from the network may be a timing for activating the first identification information, and/or the number of times of performing the UE behavior based on the first identification information for which the first identification information is activated, and/or a period for performing the UE behavior based on the first identification information for which the first identification information is activated, and/or the like, for example.

Here, the UE may recognize that the first identification information is active or is activated based on the information, and perform the behavior based on the first identification information. More specifically, for example, in a case that information related to a timing of activating the first identification information is included in the first identification information by the network, the UE may recognize that the first identification information is active at the timing indicated by the information, and perform the behavior of the UE based on the first identification information. Additionally/alternatively, for example, in a case that information related to the number of times of performing the UE behavior based on the first identification information is included, the UE may activate the first identification information until completion of the number of times of the behaviors based on the first identification information based on the information. Additionally/alternatively, for example, in a case that information related to a period for performing the UE behavior based on the first identification information is included, the UE may perform the behavior based on the first identification information activated in the period based on the information. More specifically, for example, in a case that the network designates “once” as the information indicating the number of times of performing the UE behavior based on the first identification information and designates a timing at which the UE next goes inside of the coverage through the outside of the coverage as the timing for activating the first identification information, the UE may activate the first identification information, perform the registration update procedure once as the behavior based on the first identification information in a case of next returning to the coverage, and further deactivate the first identification information, based on the information. Alternatively, for example, in a case that the network designates “one or more times” as the information indicating the number of times of performing the UE behavior based on the first identification information and designates a timing at which the UE next goes inside of the coverage through the outside of the coverage as the timing for activating the first identification information, the UE may activate the first identification information in a case of next returning to the coverage, perform the registration update procedure the number of times indicated by the network as the behavior based on the first identification information each time the UE goes inside of the coverage, and further deactivate the first identification information after repeating the behavior based on the first identification information the number of times indicated by the network, based on the information.

Note that, similarly to the first identification information, the information, indicated by the network, for indicating the condition in a case of performing the behavior of the UE based on the first identification information, the request from the network, or the like, the information being included in the first identification information and transmitted to the UE or being transmitted together as information different from the first information, may be associated with a combination of any one or more of the RAT type, and/or the PLMN, and/or the access type, and/or the area, and/or the core network or system type, and/or the access, and/or the network, and in a case that the UE returns to the coverage and the connection is changed to connection with a different combination, the first identification information may be deactivated.

As described above, for example, the first embodiment may be an embodiment in which the UE receives the UE configuration update command message or the registration accept message as the MM message including the first identification information from the network via satellite access, and in a case that the UE returns to the coverage from the outside of the coverage of the NR satellite access in discontinuous satellite coverage, the UE performs the registration update procedure for the network via the satellite access based on the first identification information received by the UE. Here, the first identification information may be identification information indicating a request to initiate the registration update procedure for the network via satellite access in a case that the UE returns to the coverage of the satellite access from the outside of the coverage of the satellite access, and further, the first identification information may be identification information related to the PLMN, and/or the RAT type, and/or the access type, and/or the area. Moreover, in a case of being inside of coverage with access and/or a network having a different association with one or more of the RAT type, and/or the PLMN, and/or the access type, and/or the area, and/or the core network or system type included in the first information, the operation based on the first identification information may be stopped temporarily or may be stopped until the UE enters the deregistered state in the access and/or the network.

### 5.2. Second Embodiment

A second embodiment in the present example will be described. In this subsection, the second embodiment is also referred to as the present embodiment.

Note that the second embodiment may be an embodiment performed after each behavior of the first embodiment is performed. Alternatively, the second embodiment may be an embodiment performed independently of the first embodiment. Alternatively, the second embodiment may be an embodiment performed irrespective of the first embodiment. More specifically, for example, the second embodiment may be an embodiment after the UE of the first embodiment receives the first identification information and performs the behavior based on the first identification information. The behaviors of the second embodiment described below overlap a part of the behaviors of the first embodiment described in Section 5.1.

First, the UE of the first embodiment receives a message including the first identification information from the network via satellite access.

More specifically, for example, the UE of the second embodiment receives the message including the first identification information from the network via satellite access during the mobility management procedure initiated by the network or during the registration procedure. Here, the first identification information may be included in the configuration update command message or the registration accept message and transmitted from the network to the UE. More specifically, for example, the UE may receive the configuration update command message including the first identification information or the registration accept message including the first identification information from the AMF via satellite access.

Moreover, the UE that has received the first identification information from the network may store the received first identification information. Moreover, in a case that the UE receives new first identification information, the UE may replace the already received and stored first identification information with the new received first identification information.

Next, in a case that the UE that has received the first identification information from the network goes out of the coverage of satellite access and then returns to the coverage in discontinuous satellite coverage, the UE may initiate or perform the registration update procedure for the network via the satellite access, based on the first identification information

Here, the access and the network for which the UE performs the registration update procedure may be the satellite access and the network from which the UE has received the first identification information. Here, the network that has transmitted the message including the first identification information to the UE may be the network with which the UE has initially registered. Moreover, the first identification information received by the UE may be related to the PLMN of the network of a transmission source and the RAT type of the satellite access, for example.

Moreover, in a case that the UE returns to the coverage of satellite access and the discontinuous coverage wait timer is running, the UE need not perform the registration update procedure. In other words, for example, in a case that the UE returns to the coverage of satellite access and the discontinuous coverage wait timer is running, the UE may wait for expiration of the timer and perform the registration update procedure after expiration of the timer.

Note that, here, the UE that has received the first identification information may repeatedly perform the registration update procedure each time the UE returns to the coverage from the outside of the coverage of satellite access, and for example, the UE may perform the registration update procedure based on the first identification information and repeatedly perform the operation in the network with which the UE registers until the UE transitions to the deregistered state.

Next, after the UE receives the first identification information, or in a case that the UE receives the first identification information and while the UE is performing the operation based on the first identification information, the UE further receives a message including the second identification information from the network via satellite access during the mobility management procedure initiated by the network or during the registration procedure.

Here, the second identification information may be included in the configuration update command message or the registration accept message and transmitted from the network to the UE. Here, for example, the registration accept message may be a message transmitted from the network to the UE and received by the UE during the registration update procedure initiated or performed by the UE based on the first identification information. Alternatively, for example, the registration accept message may be a message transmitted from the network to the UE and received by the UE during the registration update procedure initiated or performed by the UE not based on the first identification information.

The UE that has received the second identification information from the network may not initiate, or may stop, repetitions of performing the registration update procedure based on the first identification information each time the UE returns to the coverage from the outside of the coverage of satellite access, based on the second identification information.

In other words, for example, in a case that the UE of the second embodiment further receives the second identification information from the network via satellite access after receiving the first identification information from the network via the satellite access, the UE may stop initiation of the registration update procedure upon returning to the coverage from the outside of the coverage of the satellite access based on the first identification information, i.e., need not perform the registration update procedure,

Here, the second identification information may deactivate the operation based on the first identification information activated in association with the same combination of any one or more of the RAT type, and/or the PLMN, and/or the access type, and/or the area, and/or the core network or system type. In other words, the first identification information associated with a different combination of any one or more of the RAT type, and/or the PLMN, and/or the access type, and/or the area, and/or the core network or system type need not be deactivated.

A change of the core network or the system in a case that the UE returns to the coverage from the outside of the coverage of satellite access may be a change from the 5G Core Network (5GCN) or the 5G System (5GS) to the Evolved Packet Core (EPC) or the Evolved Packet System (EPS), and in a case that the core network or the system is changed, the UE need not perform the registration update procedure based on the first identification information.

As described above, for example, the second embodiment may be an embodiment in which, in a case that the UE performing the behavior based on the first identification information described in the first embodiment further receives the second identification information, the UE deactivates the behavior based on the first identification information being performed. Here, the behavior based on the first identification information deactivated by the second identification information may be the registration update procedure performed by the UE returning to the outside of the coverage from the inside of the coverage of satellite access, or repetitions of the registration procedure performed by the UE each time the UE returns to the outside of the coverage from the inside of the coverage of satellite access.

### 5.3. Third Embodiment

A third embodiment in the present example will be described. In this subsection, the third embodiment is also referred to as the present embodiment.

The UE of the third embodiment receives a message including the third identification information from the network via satellite access. Here, the message including the third identification information may be any one of the mobility management procedures initiated by the network described in Section 4. Moreover, the message including the third identification information may be the MM message or the paging message. Here, the MM message may be the configuration update command message, or the notification message, or the DL NAS transport message, for example.

The UE that has received the third identification information from the network may initiate the registration update procedure for the network via satellite access, based on reception of the third identification information.

Here, for example, in a case that the UE receives the message including the third identification information while the discontinuous coverage wait timer is running, or based on the third identification information received by the UE, the UE may stop the timer and initiate the registration update procedure for the network via satellite access.

Alternatively, conversely, in a case that the UE receives the message including the third identification information while the discontinuous coverage wait timer is running, the UE may stop the timer and need not initiate the registration update procedure. In other words, regarding the UE in this case, the UE that has received the third identification information may wait for expiration of the discontinuous coverage wait timer and perform the registration update procedure after expiration of the discontinuous coverage wait timer.

As described above, for example, the UE of the third embodiment may receive the message including the third identification information from the network via satellite access, and perform the registration update procedure via the satellite access, based on reception of the third identification information.

The third identification information may be identification information transmitted only to the UE connected via satellite access and not transmitted to the UE connected via non-satellite access. Alternatively, the third identification information may be identification information transmitted to the UE connected via any one of satellite access and non-satellite access.

The third identification information may be identification information transmitted from the network to the UE via satellite access and not transmitted from the network to the UE via non-satellite access. Alternatively, the third identification information may be identification information transmitted to the UE via any one of satellite access and non-satellite access.

### 6. Modifications

A program running on an apparatus according to the present example may serve as a program that controls a Central Processing Unit (CPU) and the like to cause a computer to function to realize the functions of the aforementioned embodiments according to the present example. Programs or information handled by the programs are temporarily stored in a volatile memory such as a Random Access Memory (RAM), a non-volatile memory such as a flash memory, a Hard Disk Drive (HDD), or another storage apparatus system.

Note that a program for realizing the functions of the embodiments according to the present example may be recorded on a computer-readable recording medium. The functions may be realized by causing a computer system to read the program recorded on the recording medium and perform the program. It is assumed that the “computer system” refers to a computer system built into the apparatuses, and the computer system includes an operating system and hardware components such as a peripheral device. The “computer-readable recording medium” may be a semiconductor recording medium, an optical recording medium, a magnetic recording medium, a medium dynamically retaining the program for a short time, or any other computer-readable recording medium.

Each functional block or various features of the apparatuses used in the aforementioned embodiments may be implemented or performed on an electric circuit, for example, an integrated circuit or multiple integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or may be a processor of a known type, a controller, a micro-controller, or a state machine instead. The aforementioned electric circuit may include a digital circuit or may include an analog circuit. In a case that a circuit integration technology that replaces the current integrated circuits appears with advances in semiconductor technologies, one or multiple aspects of the present example can also use a new integrated circuit based on the technology.

Note that the present example is not limited to the above-described embodiments. Although apparatuses have been described as an example in the embodiments, the present example is not limited to these apparatuses, and is applicable to a terminal apparatus or a communication apparatus of a fixed-type or a non-stationary electronic apparatus installed indoors or outdoors, for example, an AV apparatus, a kitchen apparatus, a cleaning or washing machine, an air-conditioning apparatus, office equipment, a vending machine, and other household apparatuses.

Although the embodiments of the present example have been described in detail above referring to the drawings, the specific configurations are not limited to those embodiments and include, for example, design changes within the scope that do not depart from the gist of the present embodiment. Various modifications are possible within the scope of the present example defined by claims, and embodiments that are made by suitably combining technical means disclosed according to the different embodiments are also included in the technical scope of the present example. A configuration in which elements described in the respective embodiments and having mutually similar effects are substituted for one another is also included.

### INDUSTRIAL APPLICABILITY

The present example can be utilized, for example, in a communication system, communication equipment (for example, a cellular phone apparatus, a base station apparatus, a wireless LAN apparatus, or a sensor device), an integrated circuit (for example, a communication chip), or a program.

### Reference Signs List

1 Mobile communication system
10 UE_A
30 PGW-U
32 PGW-C
35 SGW
40 MME
45 eNB
50 HSS
60 PCRF
80 Access network_A (E-UTRAN)
90 Core network_A
120 Access network_B (5G AN)
122 gNB
130 UPF
132 SMF
140 AMF
150 UDM
160 PCF
190 Core network_B
235 UPF_A
239 UPF_C

1.-4. (canceled)

5. A User Equipment (UE) comprising:
transmission and reception circuitry; and
a controller,
wherein
the transmission and reception circuitry is configured to receive a registration accept message that includes first information from a network,
in a case that the first information indicates the UE needs to perform a registration procedure when the unavailability period has ended, the controller is configured to:
start a timer when the UE returns to coverage after being out of coverage due to discontinuous coverage, and
perform a registration procedure, if the timer expires.

6. The UE according to claim 5, wherein
the unavailability period is a period during which the UE is out of coverage for the discontinuous coverage by satellite access.

7. The UE according to claim 5, wherein
the transmission and reception circuitry is configured to receive the first information from the network in the registration accept message before the unavailability period.

8. The UE according to claim 5, wherein
the registration procedure is a procedure for mobility registration update.

9. The UE according to claim 5, wherein
in a case that a paging message is received, the controller is configured to:
stop the timer, and
start Non-Access-stratum (NAS) signaling.
